(19) United States
(12) Patent Application Publication
(10) Pub. No.: US 2023/0390941 A1
(43) Pub. Date: Dec. 7, 2023

(54) SYSTEM AND METHOD FOR SORTING AND/OR PACKING ITEMS

(71) Applicant: WOOTZANO LIMITED, Edinburgh (GB)

(72) Inventors: Jesse OPOKU, Edinburgh (GB); François MORINI, Edinburgh (GB); Mark BECKWITH, Edinburgh (GB); Atif SYED, Edinburgh (GB)

(21) Appl. No.: 18/034,021

(22) PCT Filed: Oct. 26, 2021
(86) PCT No.: PCT/GB2021/052775

§ 371 Date: Apr. 26, 2023

(30) Foreign Application Priority Data
Oct. 27, 2020 (GB) 2017042.9

(51) Int. Cl. B25J 13/08; B25J 9/16; B65G 47/90; B07C 5/36; B65B 5/10; B65B 57/14; B65B 57/18; B65B 25/04; B65B 5/06

(52) U.S. Cl. CPC B25J 13/085; B25J 9/1612; B65G 47/905; B07C 5/36; B65B 5/105; B65B 57/14; B65B 57/18; B65B 25/046; B65B 5/068; B65G 2201/0211; B07C 2501/0081; G06V 20/68

(57) ABSTRACT

An item packing system configured to sort and/or pack items into item containers, the system comprising a robotic arm. At least one end effector for holding and manipulating an item to be sorted and/or packed, wherein at least one end effector comprises a pressure sensing assembly. A controller configured to receive sensor signals from the pressure sensing assembly to obtain an indication of a magnitude of contact pressure for contact between the end effector and the item held by the end effector. A direction of contact pressure for contact between the end effector and the item held by the end effector, wherein the controller is configured to determine whether the end effector is correctly holding the item based on the indication of the magnitude of the contact pressure and the indication of the direction of contact pressure.

### TECHNICAL FIELD

The present disclosure relates to the field of sorting and/or packing items, such as items of fruit and/or vegetables.

### BACKGROUND

Once fruit and/or vegetables have been grown and harvested, they are sorted and packed into containers for transport to vendors (such as supermarkets) where they are sold. Typically, this process involves a plurality of human operators who select which fruit/vegetables to select for packing, as well as sorting where these are to be packed. This sorting and packing may have to be performed in accordance with rules specific to the relevant fruit and/or vegetables. For example, tomatoes may have to be grouped based on their size and colour. This can involve a large number of human operators to perform this sorting and packing (e.g. there may be three human operators involved for packing six tomatoes into a punnet). This may bring about inefficiencies in the supply chain such as limiting the throughput of fruit and/or vegetables to be sorted, as well as introducing a number of subjective judgements which the human operators will have to make to determine how to sort and/or pack the fruit and/or vegetables.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided an item packing system configured to sort and/or pack items into item containers. The system comprises: a robotic arm; at least one end effector for holding and manipulating an item to be sorted and/or packed, wherein at least one end effector comprises a pressure sensing assembly; and a controller configured to receive sensor signals from the pressure sensing assembly to obtain an indication of: (i) a magnitude of contact pressure for contact between the end effector and the item held by the end effector; and (ii) a direction of contact pressure for contact between the end effector and the item held by the end effector. The controller is configured to determine whether the end effector is correctly holding the item based on the indication of the magnitude of the contact pressure and the indication of the direction of contact pressure.

Embodiments of the present disclosure may enable items to be placed into punnets in an efficient manner which may not need human interaction. Use of such a contact pressure sensing assembly in packing of items, such as items of fruit and/or vegetables may enable an objective determination of how to sort and/or pack items. This may avoid any issues or inconsistencies brought about when human operators are used to determine how to sort and/or pack items of fruit or vegetables. The robotic arm may have three degrees of freedom for its movement. The system may comprise a control unit configured to receive obtained pressure information (e.g. magnitude and direction of pressure) and to determine if the item is held properly based thereon. The control unit may be configured to control operation (e.g. movement) of the robotic arm for sorting and/or packing items based on said determination.

The system may be configured to determine if the end effector is correctly holding the item if both: (i) the indication of the magnitude of contact pressure is within a selected pressure range, and (ii) the indication of the direction of contact pressure is within a selected direction range. The system may be configured to receive an indication of the type of item to be sorted and/or packed, and wherein the selected pressure range and/or the selected direction range is selected based on the indication of the type of item. The selected range for magnitude of pressure may vary depending on the direction of pressure and vice versa. The width of the selected range may vary depending on a magnitude of the indication of pressure information. For example, where the direction of pressure information indicates a more uniform pressure distribution, the selected magnitude of pressure range may have a greater width than for less uniform pressure distributions (e.g. a greater absolute width or a greater width relative to the magnitude of pressure value). The selected range for pressure may be selected to provide a range of pressures at which the end effector should be able to hold the item without the item slipping, or falling out of the end effector, and/or at which the pressure is not too high to provide damage to the item (e.g. too much compression).

The system may be configured to determine that the end effector is not correctly holding the item if at least one of: (i) the indication of the magnitude of contact pressure has increased or decreased by more than a first amount; (ii) the indication of the magnitude of contact pressure is increasing or decreasing by more than a first rate of change; (iii) the indication of the direction of contact pressure has changed by more than a second amount; and (iv) the indication of the direction of contact pressure is changing by more than a second rate of change. The system may be configured to determine that the end effector is not correctly holding the item if at least one of: (i) the indication of the magnitude of contact pressure is changing while the indication of the direction of contact pressure remains constant; and (ii) the indication of the direction of contact pressure is changing while the indication of the magnitude of contact pressure remains constant.

In some examples the system further comprises a camera, and wherein the system is configured to use the camera to provide an indication of at least one of (i) the location and (ii) the size of the item of fruit or the vegetable, and wherein the system is further configured to move the robotic arm and control the end effector to pick up the item of fruit or the vegetable based on the indication provided by the camera. The camera may comprise a plurality of cameras. For example, a pair of cameras may be provided to provide a stereo view. The cameras may be arranged to obtain images of a plurality of different regions of the exterior surface of the item. The system may be controlled based on data obtained from the cameras. For example, data obtained may indicate whether or not an item is suitable for packing, and the system may be configured to pack and/or sort the item accordingly. Data obtained from the camera may enable a size/type/shape/colour etc. of the item to be obtained and the thresholds for controlling the system may be selected based on this data and/or the items may be placed based on this data (e.g. according to selected properties associated with punnets to be packed). For example, the system may be configured to determine whether to pack an item into an item container based on the obtained indication of size for the item, e.g. the system may be configured to determine into which of a plurality of item containers to place the item based on the obtained indication of size for the item.

The controller may be configured to: (i) obtain one or more images of each item to be sorted and/or packed; and (ii) perform an image analysis on each image to determine whether to pack that item into an item container. In the event that the controller determines that an item should be packed into an item container based on the image analysis, the controller may be configured to control the robotic arm to place said item into a said item container. In the event that the controller determines that an item should not be packed into an item container based on the image analysis, the controller may be configured to control the robotic arm so that the item is placed into a discard region. The controller may be configured to obtain at least one image of each item before said item is to be picked up by the one or more end effectors, and in the event that the controller determines that said item should not be packed into an item container based on the image analysis of said at least one image obtained before the item is to be picked up, the controller may be configured to control the robotic arm not to pick up the item. The controller may be configured to obtain at least one image of an item after said item has been picked up by the one or more end effectors, and in the event that the controller determines that said item should not be packed into an item container based on the image analysis of said at least one image obtained after the item has been picked up, the controller may be configured to control the robotic arm to place the item in the discard region, e.g. the end effector may be configured to perform a firmness test on the item and, in the event that the item does not pass the firmness test, to place the item into the discard region.

In the event that the controller determines that the one or more end effectors are not correctly holding the item, the controller may be configured to control at least one of the end effectors to move relative to the item. Controlling at least one of the end effectors to move may comprise at least one of: (i) moving the end effector inwards to increase its contact pressure on the item in the event that the magnitude of contact pressure is too low; (ii) moving the end effector outwards to decrease its contact pressure on the item in the event that the magnitude of contact pressure is too high; and (iii) moving the end effector around the item to a different location on the surface of the item in the event that the direction of contact pressure is not in the correct direction. In the event that the system determines that the one or more end effectors are not holding the item correctly, the system may perform at least one of the following actions: (i) rejects the item for review; (ii) logs the rejection in a database, optionally with a timestamp; (iii) triggers an alert notification; (iv) returns the item to where it was picked, for example to enable further visual inspection of the item; (v) attempts to obtain a new indication of the size of the item; (vi) determines if the item is bruised or damaged; and (vii) provides feedback for use in training a machine learning algorithm.

The system may comprise a light detection and ranging, LIDAR, apparatus for determining a distance to the item. The system may be configured to use a determined distance to the item to facilitate picking and/or to determine item size. The system may comprise at least one of: (i) a chemical sensor for detecting the chemical composition of the item held by said end effector, (ii) a ripeness sensor for detecting the ripeness of the item held by said end effector, and (iii) a firmness sensor for detecting how firm the item is, for example wherein the firmness sensor comprises a camera configured to perform visual inspection of the item. For example, one or more of the end effectors may comprise the chemical sensor, ripeness sensor and/or firmness sensor, and/or such sensors may be provided by additional components of the system, e.g. the sensors may be provided at least in part by a visual inspection system (e.g. one or more cameras and a controller configured to perform image analysis of images of the items obtained by the cameras). The system may be controlled based on an obtained indication of ripeness, such as to sort items based on their ripeness (e.g. group items of similar ripeness into the same punnets, or organise punnets so that each punnet has items at different levels of ripeness therein). Overly ripe items may be discarded, as may items which are too soft or firm. The at least one end effector may comprise three digits. Each digit may have a corresponding pressure sensor.

The pressure sensing assembly may comprise an electronic skin made from a substrate comprising: a base polymer layer; a first intermediate polymer layer attached to the base polymer layer by a first adhesive layer, the first intermediate polymer layer comprising a first intermediate polymer in which electron-rich groups are linked directly to one another or by optionally substituted C₁₋₄ alkanediyl groups; and a first conductive layer attached to the first intermediate polymer layer by a second adhesive layer or by multiple second adhesive layers between which a second intermediate polymer layer or a second conductive layer is disposed.

The nanowires may comprise a conductive material, and preferably a metallic conductive material, where the metal in the metallic conductive material is preferably selected from zinc and silver, and more preferably is zinc, e.g. in the form of zinc oxide. The metallic conductive material may be in a crystalline form. The nanowires may extend away from the surface of the first conductive layer. A first end of the nanowires may be tethered to the first conductive layer. The nanowires may have an aspect ratio of from 1.5 to 100, preferably from 4 to 50, and more preferably from 6 to 20. The nanowires may be substantially vertically aligned. The nanowires, e.g. the surface of the nanowires may be functionalised with a species which enhances the sensory, e.g. piezoresistive or piezoelectric, response of the electronic skin when it comes into contact with a target species, for instance the nanowires may be functionalised with a binder, a catalyst or a reagent. The nanowires may be functionalised with a functional group, preferably selected from amino (—NH₂), hydroxy (—OH), carboxy (—COOH), amido (—CONH₂) and sulfanyl (—SH) groups. The nanowire may be functionalised with a catalyst, the catalyst preferably cleaving a target species into sub-sections, with one of the sub-sections inducing a sensory response in the electronic skin.

The substrate may comprise a pair of electrical contacts through which a sensory response of the nanowires is transmitted. For example, said substrate may provide pressure sensing for the digits, e.g. the pressure sensor may comprise the electronic skin on the digits. The substrate may comprise a third conductive layer to which the second end of each nanowire is preferably tethered. A sensory, e.g. piezoelectric, response of the nanowires may be transmitted through a pair of electrical contacts, one of which is attached to the first conductive layer and the other of which is attached to the third conductive layer. The first and third conductive layers may be attached to one another by a third adhesive layer or, preferably, by multiple (e.g. two) third adhesive layers between which a third intermediate polymer layer is disposed. The conductive layer may have a thickness of from 10 to 300 nm, preferably from 25 to 200 nm, and more preferably from 50 to 100 nm. The electronic skin may comprise electrical connection means which are suitable for electrically connecting the conductive layer, e.g. via the electrical contacts, to a signal receiver (e.g. a computer such as the control unit), the electrical connection means being preferably selected from wires, flex circuits and plug and play slots; and/or a support to which the one or more substrates are attached.

Pressure sensing assemblies of the present disclosure may comprise a contact pressure sensing assembly comprising: an electronic skin for the digits of the end effector of the robotic arm, wherein the electronic skin may comprise: (i) a plurality of piezoresistive sensors each configured to obtain piezoresistive signals; and (ii) a plurality of piezoelectric sensors each configured to obtain piezoelectric signals, thereby to provide the pressure sensing assembly. A control unit of the present disclosure may be coupled to the electronic skin to receive the piezoresistive and piezoelectric signals therefrom. The control unit may be configured to process the piezoresistive signals to identify one or more piezoresistive parameters associated therewith, and to process the piezoelectric signals to identify one or more piezoelectric parameters associated therewith. The control unit may be operable to identify that an item held by the digits of the end effector is moving relative to the electronic skin based on a difference in magnitude and/or phase between: (i) one or more of the piezoelectric parameters in piezoelectric signals from one piezoelectric sensor, and (ii) one or more of the piezoelectric parameters in piezoelectric signals from another piezoelectric sensor. The control unit may be configured to determine a contact pressure between the item and a first digit associated with said one piezoelectric sensor based on one or more of the piezoresistive parameters from piezoresistive signals associated with the first digit.

Such a contact pressure sensing assembly Embodiments may enable more responsive and/or precise pressure sensing, as well as to enable more reliability in pressure sensing, as results from piezoelectric sensors may provide complementary information to that obtained using piezoresistive sensors (and vice versa). For example, the combination of sensor data may enable the assembly to perform a cross-checking or comparison between sensor data (e.g. to increase reliability that a measurement from one type of sensor is correct). The assembly may be able to detect an indication of a change in pressure (e.g. due to some movement of the item relative to the digit) using the piezoelectric sensors, and to monitor an indication of the contact pressure (e.g. its magnitude/direction etc.) using the piezoresistive sensors. This may enable quicker detection of movement in combination with real-time monitoring of contact pressure.

In response to identifying that an item held by the digits of the end effector is moving relative to the electronic skin for the first digit based on the piezoelectric signals, the control unit may be configured to monitor piezoresistive signals associated with the first digit to confirm that the item is moving relative to the electronic skin for the first digit. The control unit may be configured to determine a direction of movement of the item based on a phase difference between different piezoelectric signals. For at least one of the digits of the end effector, the electronic skin may comprise a first piezoelectric sensor and a second piezoelectric sensor located away from the first piezoelectric sensor. The control unit may be configured to determine whether the item is moving in the direction of the first piezoelectric sensor or the second piezoelectric sensor based on piezoelectric signals from the first and second piezoelectric sensors. The one or more piezoresistive parameters may comprise a change in voltage associated with the sensor, and/or wherein the one or more piezoelectric parameters comprise any of: a maximum voltage, a minimum voltage, a change in voltage and/or a rate of change of voltage. The control unit may be configured to control at least one of the digits to move relative to the item, wherein the control unit is configured to determine a direction in which the digit is to move based on the determined direction of movement of the item. In the event that the control unit determines that the item is moving relative to a first digit, the control unit may be configured to determine a contact pressure between the item and the first digit based a change in voltage from piezoresistive signals on the first digit. For example, the control unit may control the digit to move to a location where it can oppose the direction of movement of the item.

The pressure sensing assembly may be configured to obtain a spatial distribution of contact pressure for contact between the digits and the item held by the digits based on contact pressure measurements at each of a plurality of different locations on the digits. The system may be configured to identify an indication of directionality in the contact pressure between the digits and the item based on the spatial distribution of contact pressure. The system may be configured to determine whether the digits are correctly holding the item based on the spatial distribution of contact pressure and the indication of directionality in the contact pressure between the digits and the item.

The system may be configured to receive an indication of the type of item of fruit or vegetable. The selected range for pressure may be selected based on the indication of the type of item of fruit or vegetable. For example, the system may be configured to obtain an indication of suitable pressure values for each type of fruit and/or vegetable used in the system. Based on the obtained indication of the type of item, the system may be controlled so that the pressure remains within the selected range for that particular type of item. The system may be configured to receive an input indicating the type of item (e.g. from an image processing element of the system or as input from a human operator of the system). Based on the input of type of item, the system may identify the selected ranges for pressure (e.g. based on historic data).

In examples, the system may comprise a displacement sensor configured to obtain an indication of relative displacement between the end effectors, e.g. between the different digits. The packing system may be configured to determine that the end effector is not correctly holding the item of fruit or the vegetable if at least one of: (i) the indication of pressure (magnitude and/or direction) is changing while the indication of displacement remains substantially constant, and (ii) the indication of displacement is changing while the indication of pressure (magnitude and/or) remains substantially constant. For example, (i) may represent slipping of the item, and/or (ii) may represent squashing of the item. Changing may comprise a total change in value above a threshold amount, or a change at or above a selected rate of change.

The displacement sensor may be provided, at least in part, by a camera (e.g. one of the cameras mentioned above). The system may be configured to allocate the item of fruit or the vegetable to one of a selected number of punnets based on the indication of the size. For example, the system may be configured to identify a plurality of open punnets (e.g. non-full punnets into which items are to be placed). The system may be configured to identify one or more selection criteria associated with each open punnet, such as an indication of a requirement for one or more properties of an item which is to be placed into said open punnet.

For example, selection criteria for an item to be placed into an open punnet may comprise an indication of at least one of: (i) a size of an item, (ii) a shape of an item, (iii) a colour of an item, (iv) a ripeness and/or firmness of an item, (v) a type of item, (vi) a chemical composition of an item, and/or (vii) a suitability of an item such as a number of deficiencies associated with that item. The system may be configured to identify relevant properties of an item to be packed and to select the open punnet into which that item is to be placed based on the one or more properties associated with the item and the relevant selection criteria associated with the open punnets. For example, the system may be configured to obtain an indication of the property of the item (e.g. its size) and to select an open punnet based on that property (e.g. an open punnet intended to receive items of that size). In the event that there is a match (e.g. a suitable open punnet for that item), the system is configured to place that item in said punnet.

The system may be configured to allocate the item of fruit or the vegetable to one of a selected number of punnets based (i) on the indication of the size of the item of fruit or the vegetable and (ii) based on the remaining space in each of the selected punnets. A data store of the system may store an indication of open punnets and what spaces they have available (as well as criteria associated with open punnets which specify which items are to be placed in said punnets), and/or punnet availability may be determined on-the-fly, such as using a camera to identify open spaces.

The system may be configured to allocate the item of fruit or the vegetable to one of a selected number of classes based on the indication of the size. The system may be operable to sort the item of fruit or the vegetable into a punnet based on the allocation. The selected range may be determined based on an indication of size of the item of fruit or the vegetable provided by the camera. Parameters associated with the item (such as selected ranges for operation) may be selected depending on the type or size of item (e.g. firmness etc.). The system may be configured to use the camera to obtain the indication of the type of item. The system may be configured to obtain one or more images of the item which are processed to identify the type of item. The system may be configured to perform an image analysis (e.g. using image recognition, such as using a machine learning element configured to process images to obtain an indication of the type of item present in the image). The system may be configured to analyse the image and to provide an output indicating a type of item present. The system may be configured to control operation of the end effector based on said type of item (e.g. to choose appropriately selected thresholds for the item based on its type and/or to determine into which open punnet to place said item based on its type).

Aspects of the present disclosure are directed to fruit and/or vegetable packing systems configured to sort and/or pack items of fruit and/or vegetables into open punnets, e.g. wherein items disclosed herein comprise items of fruit and/or vegetables. The item picking system may be configured to pick items of fruit or vegetables. For example, it may be configured to handle softer or more delicate items than e.g. boxes. For example, this may comprise use of higher sensitivity pressure sensors, e.g. which are operable to obtain an indication of pressure sufficiently precisely between a pressure value which is too high and which may damage the fruit/vegetable, and pressure value at which the item cannot be held, to enable the items to be grasped and moved without being dropped or damaged by over-squeezing.

In an aspect, there is provided a method of sorting and/or packing items into item containers by a robotic system, the robotic system comprising a robotic arm and one or more end effectors coupled to the robotic arm for holding and manipulating an item. The method comprises: receiving an indication of a magnitude of contact pressure for contact between at least one end effector and the item held by the one or more end effectors; receiving an indication of a direction of contact pressure for contact between at least one end effector and the item held by the one or more end effectors; determining whether the one or more end effectors are correctly holding the item based on the indication of the magnitude of the contact pressure and the indication of the direction of contact pressure.

The method may comprise determining if the one or more end effectors are correctly holding the item if both: (i) the indication of the magnitude of contact pressure is within a selected pressure range, and (ii) the indication of the direction of contact pressure is within a selected direction range. The method may comprise determining that the one or more end effectors are not correctly holding the item if at least one of: (i) the indication of the magnitude of contact pressure has increased or decreased by more than a first amount; (ii) the indication of the magnitude of contact pressure is increasing or decreasing by more than a first rate of change; (iii) the indication of the direction of contact pressure has changed by more than a second amount; (iv) the indication of the direction of contact pressure is changing by more than a second rate of change; (v) the indication of the magnitude of contact pressure is changing while the indication of the direction of contact pressure remains constant; and (vi) the indication of the direction of contact pressure is changing while the indication of the magnitude of contact pressure remains constant.

In an aspect, there is provided an apparatus for sorting items, the apparatus comprising: a hopper for receiving items; a chute for receiving one item, the chute having a first open end for receiving an item from the hopper, and a second open end configured to release the item to a dispenser. The chute comprises a camera and a rotating means, the rotating means configured to rotate the item in the chute in front of the camera to enable the camera to obtain a plurality of different images of the item before the item is released to the dispenser.

The camera and rotating means may be coupled to a controller. The controller may be configured to operate the camera and rotating means to obtain a plurality of still frames of the item viewed from different orientations. The controller may be configured to analyse the plurality of still frames to determine if any regions of the item contain blemishes or defects, e.g. the chute and the rotating means may comprise a rotating conveyor. The controller may comprise the controller disclosed above. For example, the controller may be configured to control operation of the system for sorting and/or packing items of fruit and/or vegetables, e.g. the controller configured to control operation of the robotic arm and digits of the end effector coupled to the robotic arm. Systems for sorting and/or packing disclosed herein may comprise said apparatus for sorting. For example, the second open end may be configured to provide items to the robotic arm and/or the rotating means may comprise the robotic arm, e.g. so that an indication of how to sort items may be obtained, based on which, the system may be configured to control where to pack the items, such as into which open punnet the items are to be packed.

Aspects of the present disclosure may provide a computer readable non-transitory storage medium comprising a program for a computer configured to cause a processor to perform any of the methods disclosed herein.

### FIGURES

Some examples of the present disclosure will now be described, by way of example only, with reference to the figures, in which:

FIG. 1 shows a schematic diagram of an exemplary system for sorting and/or packing items of fruit and/or vegetables.

FIG. 2a shows a schematic diagram of an exemplary system for sorting and/or packing items of fruit and/or vegetables.

FIG. 2b shows a schematic diagram of an exemplary system for sorting and/or packing items of fruit and/or vegetables in a perspective view.

FIG. 2c shows a schematic diagram of an exemplary system for sorting and/or packing items of fruit and/or vegetables in a plan view.

FIG. 3 shows a flowchart depicted an exemplary method of operation of a system for sorting and/or packing items of fruit and/or vegetables.

In the drawings like reference numerals are used to indicate like elements.

### SPECIFIC DESCRIPTION

Embodiments of the present disclosure are directed to systems and methods for sorting and/or packing items, such as items of fruit and/or vegetables. A robotic arm is used in combination with an end effector coupled to the end of the robotic arm. The end effector is operable to grasp an item of fruit or vegetable (e.g. the end effector may comprise one or more digits). A pressure sensing assembly is used to identify a property of the item of fruit or vegetable which is grasped by the end effector, such as its size, shape, ripeness or whether the item is held correctly (e.g. whether it is moving relative to the digits). The robotic arm may then control movement of the item of fruit or vegetable, e.g. to place it into a punnet which is selected based on this identified property. Embodiments of the disclosure are also directed to systems and methods which utilise one or more cameras to determine one or more properties of the item of fruit and/or vegetable, such as colour, shape, or any other property indicative of where that item should be placed (e.g. whether it should be discarded). Embodiments may utilise machine learning to provide improved image detection and classification of items of fruit and/or vegetables.

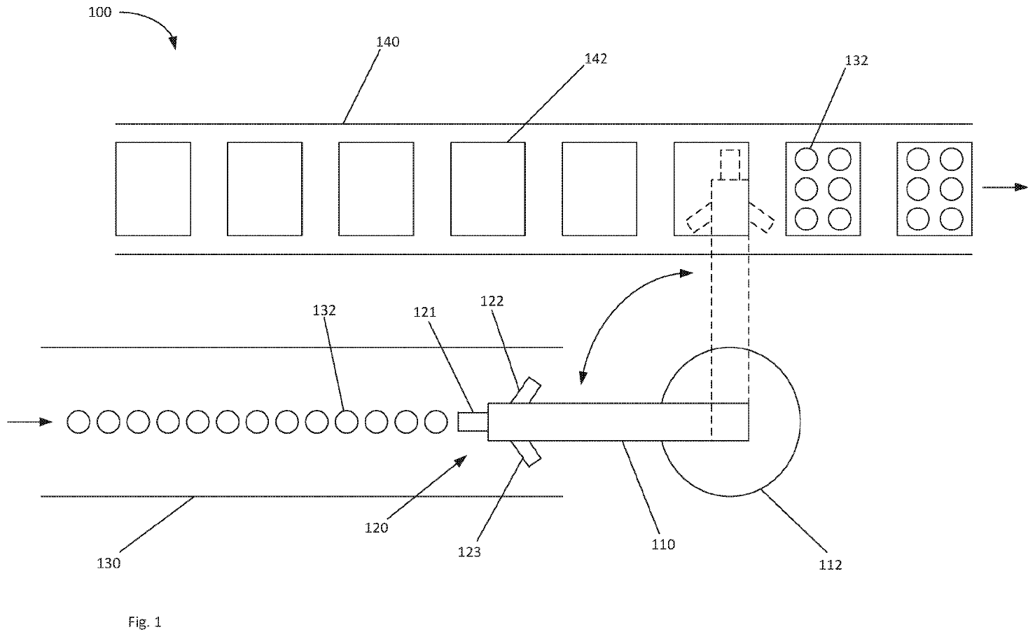

An exemplary fruit and/or vegetable packing system will now be described with reference to FIG. 1.

FIG. 1 shows a fruit and vegetable packing system 100. The system 100 includes a first robotic arm 110 which has a first end effector 120 coupled thereto. In the example of FIG. 1, the first 35 end effector 120 comprises three end effectors in the form of digits. As such, the first end effector 120 includes a first digit 121, a second digit 122 and a third digit 123. The first robotic arm 110 is provided on a movable platform 112. The system 100 also includes a first moving surface 130 and a second moving surface 140. A plurality of items or fruit or vegetables 132 are provided on the first moving surface 130, and a plurality of punnets 142 are provided on the second moving surface 140 into which the items of fruit or vegetables are placed.

The first robotic arm 110 extends radially outward from a central region. The arm has a proximal end located proximal to the central region and a distal end located away from the central region. The first end effector 120 is coupled to the robotic at or proximal to its distal end. The digits of the first end effector 120 are arranged about the distal end of the arm. In the example shown, there are three digits (although it is to be appreciated that this is merely an example, other numbers may be provided), and these are distributed about the distal end of the arm. As shown, they are distributed evenly about a coupling point between the first end effector 120 and the first robotic arm 110 (e.g. they each extend radially outwardly from this coupling point, and are separated by 120°). Each digit is coupled to a body of the first end effector 120 or the first robotic arm 110 at a coupling end of the digit, and each digit extends from its coupling end to its grasping end, which is distal to the first end effector 120 body/first robotic arm 110. The first robotic arm 110 includes one or more (e.g. two) rotation points, such as hinges, along its length from its proximal end to its distal end. The first robotic arm 110 is provided on top of the movable platform 112.

The first moving surface 130 is located close enough to the second moving surface 140 for the first robotic arm 110 to move fruit or vegetables from the first moving surface 130 to the second moving surface 140. This movement may comprise a rotation of the arm (although additionally or alternatively, the radius of the arm may be shortened or lengthened for this process). In the example shown, the first moving surface 130 runs parallel to the second moving surface 140. The first robotic arm 110 may rotate approximately 90° when moving between the moving surfaces.

The first robotic arm 110 is configured to rotate about its central axis (e.g. a vertical axis at the proximal end of the first robotic arm 110). The first robotic arm 110 is operable to shorten or lengthen its radius. This shortening/lengthening may be provided by raising or lowering a rotation point of the first robotic arm 110. The first robotic arm 110 is operable to vary the height of the distal end of the first robotic arm 110. For example, the first robotic arm 110 is configured to pivot about its proximal end (e.g. about a point on the vertical axis at the proximal end). This may increase or decrease the height of the distal end of the first robotic arm 110 depending on the pivoting direction. The first robotic arm 110 is coupled to one or more driving means, such as a motor, which are configured to control any of the rotating/pivoting/lengthening/shortening movement of the arm. The arm is configured to enable fruit or vegetables to be grasped and lifted from the first surface 130, then moved so that they may be placed into punnets 142 on the second surface 140.

The movable platform 112 is configured to provide a secure base from which the robotic may operate. The movable platform 112 is configured for movement of the first robotic arm 110, e.g. between different locations in a warehouse. The movable platform 112 may comprise a trolley. The height of the first robotic arm 110 above ground may be varied by the movable platform 112 (e.g. the height of the movable platform 112 may be adjustable, or different height movable platforms may be used). For example, the movable platform 112 may enable the robotic arm 110 to be transported to different packing stations, e.g. where it may subsequently be used to pack a different item of fruit or vegetable.

The first end effector 120 and its digits are configured for grasping items of fruit and/or vegetables. The first end effector 120 is configured so that the fruit or vegetables can be held tightly enough that they do not fall from the first end effector 120. The system may control operation of the first end effector 120 so that items are not held so tightly that they are damaged in the process. Each of the digits may be independently movable. This may comprise translational movement (e.g. in a horizontal plane), as well as rotational movement (e.g. about their connection point to the body of the first end effector 120 and/or the first robotic arm 110). Each digit may be configured to increase or decrease its length from the first robotic arm 110, such as to vary its height. This may bring the grasping end closer to, or further away from, the first robotic arm 110. For example, each digit may include one or more rotation points along its length about which rotation may provide lengthening or shortening of the digit. For example, the digits may comprise one or more pivot points to enable rotation along their length, e.g. they may be operable to operate in a manner analogous to human fingers. Movement of the digits is controlled by a driving means, such as a motor.

At least one of the digits comprises a pressure sensing assembly. The pressure sensing assembly may comprise a plurality of different contact points on the digits which are each arranged to enable an indication of the pressure being applied to the fruit or vegetable by that region of the digit to be obtained. The pressure sensing assembly is configured to give a plurality of sensor readings in the time period for grasping an item of fruit or vegetable (e.g. from a plurality of different contact locations on the digit). The system 100 is configured to monitor the pressure on the fruit or vegetable during the process of picking and placing into a punnet 142. The pressure may be used to determine when it is safe to lift an item of fruit or vegetable (e.g. once the pressure is above a threshold level), and/or whether the item is being held correctly (e.g. if it is moving relative to one or more of the digits). The system 100 is configured to control movement of the digits based on the pressure reading. For example, in the event that the pressure is too low in one or more regions (e.g. it is below a threshold value), or is decreasing, the digits may be moved to increase this pressure (moved towards each other, and/or in a direction based on a determined direction of movement for the item). Likewise, digits may be moved apart if the pressure is too high. The system 100 is configured to use pressure readings to determine that the fruit or vegetable is held securely enough to be moved, but not too tightly that it will be damaged during movement.

The first surface 130 is arranged to move items of fruit and/or vegetables towards the first robotic arm 110 and first end effector 120. The first surface 130 is configured to provide items to the first robotic arm 110 at a speed and frequency to enable the arm and first end effector 120 to grasp each item and place it accordingly. The first surface 130 may be switchable between moving and being stationary. Each item may be moved into a collection region, where that item is within reach of the first robotic arm 110. Once an item is in the collection region, the first surface 130 may be stopped to enable that item to be collected by the arm. However, it is to be appreciated that the first surface 130 may run continuously at a speed selected so that each item is in the collection region at the correct time. Items are placed on the first surface 130 at a proximal end of the first surface 130, and moved towards the first robotic arm 110 at a distal end of the first surface 130. The items may be arranged on the first surface 130 so that one item is collected at a time. The first surface 130 may be a conveyor belt.

The second surface 140 is arranged to move open punnets (e.g. punnets with room for more fruit and/or vegetables) towards the first robotic arm 110 so that the robotic may place items from the first surface 130 into open punnets on the second surface 140. The second surface 140 is arranged to move full punnets onwards away from the first robotic arm 110. The second surface 140 is arranged so that open punnets are loaded onto a proximal end of the second surface 140. The second surface 140 is configured to move these open punnets in a distal direction so that they pass within reach of the first robotic arm 110, and then onwards to a distal end of the second surface 140. As with the first surface 130, the second surface 140 may either stop and start to facilitate placement of items in punnets, or it may run continuously at a speed to enable each punnet to be filled while within a filling region of the second surface 140 in which it is within reach of the first robotic arm 110. The second surface 140 may be a conveyor belt.

Items of fruit or vegetable may comprise any suitable fruit or vegetable which are to be packed into punnets. For example, tomatoes, grapes, strawberries etc. may all be used. Punnets may comprise any suitable container for storing the relevant items of fruit or vegetable. The second surface 140 will receive punnets in an open state so that they may be packed. Once packed, punnets may be sealed. However, it is to be appreciated in the context of the present disclosure that the system may find utility for other items (e.g. which are not items of fruit or vegetable, such as other foodstuffs to be packaged into item containers).

The pressure sensing assembly may comprise a plurality of different contact sensing locations on one or more of the digits. In other words, the pressure sensing assembly may comprise a plurality of spatially distributed pressure sensors. This distribution of pressure sensors may be configured to obtain a spatial distribution of contact pressure for contact between the digits of the end effector and an item held by the digits. This spatial distribution of contact pressure may comprise an indication of a magnitude of contact pressure for contact between at least one of the digits and the item held by the digits. The spatial distribution of contact may comprise a plurality of such magnitudes of contact pressure for contact at each of a plurality of different locations. Based on the plurality of different contact pressure sensing measurements, an indication of a direction of contact pressure for contact between the at least one item and the digits may be obtained. This indication of a direction of contact pressure may comprise an indication of how contact pressure varies across different regions of the surface of the item. This may also provide an indication of higher and lower pressure regions, and this may provide an indication of directionality for pressure between the digits and the item. For example, if two adjacent sensors have different contact pressures, this may indicate that one is gripping tighter than the other, e.g. because one of the sensors is on a digit which is in the wrong place, and/or the shape of the item may be such that the pressure distribution is not even for contact with said item. The spatial distribution of contact pressure may provide an indication of a direction in which one or more of the digits could move relative to the item to get a better grip on the item (e.g. so that the item is no longer moving, or contact pressure between the digits and the item is more evenly distributed about the items surface).

The plurality of contact pressure sensing locations are configured to repeatedly (e.g. continuously) provide contact pressure sensing data. For example, each contact pressure sensing location may comprise a piezoresistive sensor configured to monitor a voltage drop associated with contact in that contact sensing region. The plurality of contact sensors are arranged to enable detection of movement of the item relative to the digits. For example, the contact sensing regions may be distributed about the one or more digits to provide an indication of pressure for the majority or all of the contact area of the digit. The system may be configured to monitor the spatial distribution of pressure, and how this changes over time, to determine if an item is moving. For example, if pressure in one region is decreasing (e.g. consistently decreasing, or has moved to a low value), it may be inferred that the item is moving away from that region (and thus there is no contact, i.e. contact pressure, between the digit and the item in that region).

In some examples, the system 100 may also include a displacement sensor (not shown in FIG. 1). However, it is to be appreciated in the context of the present disclosure that a displacement sensor is not essential, as movement of items may be controlled based on sensor signals from the pressure sensing assembly. The displacement sensor may be operable to provide an indication of the displacement between digits, and/or an indication of displacement of an digit from a reference point (e.g. a central location). The displacement between digits may be determined using coordinates associated with the movement of the digits. For example, displacement of the digits could be calibrated to a first position (e.g. when they are touching, or at maximum separation), then each time an digit is controlled to move, the position or relative displacement of the digits is updated based on this movement. A camera and image analysis could be used to determine the displacement between digits, as could other displacement sensing technology. The displacement sensing may be used in combination with sensors from the pressure sensing assembly to enable an indication of a size of the item being grasped to be obtain. It will be appreciated that the size to be measured may vary depending on the type of item. For example, a diameter of the item may be used for circular-shaped items such as tomatoes. Depending on the number and/or arrangement of digits, this size may correspond directly to the displacement between two digits or it may be determined based on relative displacement of the digits, e.g. based on a geometric relationship between the digits. For example, where the object is circular, a diameter of the object may be determined based on the displacement of any one digit from its central point (i.e. where radius is zero).

The system 100 is configured to control operation of the first robotic arm 110 and first end effector 120 based on sensor signals from the pressure sensing assembly. For example, the system 100 may be configured to control operation of the first robotic arm 110 and the first end effector 120 based on an indication of both: (i) a magnitude of one or more contact pressures, and (ii) a direction of contact pressure. In examples, where a displacement sensor is provided, the system 100 may be configured to control operation of the robotic arm 110 and the first end effector 120 based also on displacement measurements. For example, the system 100 may be configured to determine a size of the item and to pack items based on their determined size. Items on the first surface 130 may range in size and the system 100 may be configured to determine a size of the items and to pack them into punnets based on their size. For example, each punnet may be filled with items within a selected range of sizes, and the system 100 may be configured to place each item into a relevant punnet based on the determined size of the item. For some punnets, each item to be placed in the punnet may have to be within a selected size range, whereas other punnets may have a selected number of items in where the size for some of these items are different to others in that punnet.

Each open punnet may have one or more associated item sizes for items to be placed in that open punnet. The system 100 is configured to determine a size of an item held by the first end effector 120 and to identify an open punnet waiting to receive an item of that size. For example, the system 100 may be configured to identify an open punnet using image recognition of the open punnets on the second surface 140 and/or the system 100 may store an indication of open punnets (the location for which may be determined using image recognition and/or by controlling movement of the second surface 140 so that each open punnets is in a selected location). The system 100 is configured to control the first robotic arm 110 and first end effector 120 to place that item in that open punnet. Not all items may be placed in punnets. For example, the system 100 may determine that an item is too big or too small for any of the punnets, and this item may be placed in a different region where it may be e.g. discarded or transported elsewhere for packing. Open punnets closer to the distal end of the second surface 140 may be prioritised over those nearer the proximal end of the second surface 140, or open punnets may be filled one at a time (e.g. a first open punnet will be filled with items before then filling a subsequent open punnet). The system 100 may be configured to place an item into the distalmost open punnet intended to receive an item of that size. Once a selected number of items are placed into a punnet, that punnet will be full (e.g. one punnet may hold six items, such as tomatoes). The system 100 may be configured to avoid placing items in full punnets.

The system 100 may be configured to determine the size of an item also using the pressure measurements. The system 100 is configured to determine whether the first end effector 120 is correctly holding the item. This may comprise determining the size of the item using the displacement sensor and also using the pressure sensor to corroborate that this size seems plausible. Determining whether the first end effector 120 is correctly holding the item may comprise using the pressure sensor to determine how tightly gripped the item is. For example, at a pressure below a selected threshold, it may be determined that the digits are not adequately gripping the item (e.g. they may need to move closer to one another/towards the item and so the size of the item is smaller than the displacement between digits would suggest). As another example, at a pressure above a selected threshold, it may be determined that the digits are gripping the item too tightly (e.g. they may need to be separated further and so the size of the item is greater than the displacement between the digits would suggest).

The system 100 may be configured to determine that the first end effector 120 is correctly holding the item based on a direction of contact pressure. For example, if the spatial distribution of contact pressures indicates that the item has an even distribution of contact pressure with the digits, e.g. if all, or a majority, of the contact pressure measurements are within a selected range from one another, it may be determined that the item is held correctly. The system 100 may be configured to determine that the first end effector 120 is correctly holding the item based on an indication of whether the item is moving relative to the digits. For example, if it is determined that the item is stationary, e.g. moving below a threshold speed, relative to the digits, then it may be determined that the item is held correctly.

In examples where a displacement sensor is included, the system 100 may be configured to determine that the first end effector 120 is correctly holding the item based on a comparison of an indication provided by the pressure sensor with an indication provided by the displacement sensor. The size of the item may be determined based on this comparison. For example, in the event that the pressure is within a selected range, the system 100 may be configured to determine the size of the item based on the displacement sensor. Once the size of item is determined, the system 100 may be configured to place the item into a corresponding punnet (e.g. into a punnet intended to take items within a selected range within which the determined size is).

In examples where a displacement sensor is included, determining whether or not the first end effector 120 is correctly holding the item may be based on more than one measurement for pressure and/or displacement. The system 100 may be configured to monitor pressure and/or displacement values over time to identify if the first end effector 120 is correctly holding the item. The system 100 may be configured to determine that incorrect holding is happening if one or both of the pressure and displacement values are changing over time (e.g. rate of change is above a threshold rate of change, or total change is above a threshold value).

The system 100 may be configured to determine that an item is not held correctly if, based on sensor signals from the pressure sensing assembly, it is determined that at least one of: (i) a magnitude of contact pressure (e.g. from one or more of the contact pressure sensing regions) has changed by more than a first amount; (ii) a magnitude of contact pressure (e.g. from one or more of the contact pressure sensing regions) is changing by more than a first rate of change; (iii) a direction of contact pressure has changed by more than a second amount; (iv) a direction of contact pressure is changing by more than a second rate of change; (v) a magnitude of contact pressure is changing while the indication of the direction of contact pressure remains constant; (vi) a direction of contact pressure is changing while the indication of the magnitude of contact pressure remains constant; (vii) the item is moving at more than a threshold speed relative to the digits of the end effector; and (viii) the item has moved more than a threshold distance relative to the digits of the end effector.

In examples where a displacement sensor is included, if the pressure decreases while the displacement remains constant, it may be determined that the item is moving (e.g. slipping) or shrinking (e.g. it has been burst or overly-compressed), and the displacement may need to be reduced to ensure there is sufficient pressure to hold the item. If the pressure increases while the displacement remains constant, it may be determined that the item is moving (e.g. into a narrower region of the first end effector 120) or is expanding (e.g. due to too much pressure in one or more regions of the item), and the displacement may need to be increased to inhibit damage to the item. If the displacement decreases while the pressure remains constant, it may be determined that the item is being compressed or has moved, and the displacement of the digits may need to be controlled to reduce the pressure. If the displacement increases while the pressure remains constant, it may be determined that the item is expanding or has moved, and that the digits may need to be controlled to increase the pressure.

In examples where a displacement sensor is included, the system 100 may be configured to control operation of the digits based on both pressure and displacement. The system 100 may be configured to control operation so that one of pressure or displacement remains in a selected range (e.g. remains constant, or at least substantially constant). For example, the separation of the digits may be controlled so that the pressure they exert on the item remains in a selected range. As another example, the pressure exerted by the digits may be controlled so that the displacement between them remains in a selected range. The selected ranges for pressure and/or displacement may be selected based on the relevant items of fruit and/or vegetables. For example, the system 100 may be configured to receive an indication of one or more items of fruit and/or vegetables which are to be packed, and the corresponding range of pressure/displacement values may be selected for these items. Based on an indication of displacement, it may be determined what item is to be grasped, and the displacement/pressure thresholds selected accordingly.

In the event that it is determined that the item is not being held correctly, the system 100 may be configured to move one or more of the digits relative to the item.

Where the magnitude of contact pressure in a contact region is outside a selected range, the corresponding digit may be moved relative to the item so that the contact pressure is in the selected range. If the contact pressure between a digit and the item is too high, that digit may be moved away from the digit until the contact pressure is within the selected ranged, and vice versa.

Where the direction of contact pressure indicates a non-uniform distribution of pressure on the item, one or more of the digits may be moved to balance the distribution of pressure to the item. If one or more of the contact pressure sensing regions indicate a contact pressure which is outside a selected range from contact pressures from other contact pressure sensing regions (e.g. too high or too low), the digit may move relative to the item to provide a more balanced spatial distribution of contact pressure. This may comprise moving the digit towards or away from the centre of the item, and/or moving the digit to a different location on the surface of the item. For example, the direction of contact pressure may suggest a higher contact pressure between one part of a digit than another part of that same digit. From this it may be inferred that the shape of the item is such that the digit is in the wrong place, e.g. the shape may be non-uniform. The digit may be controlled to move around the surface of the item to a location where the contact pressure distribution between that digit and the item becomes more uniform, e.g. so that any irregularities in shape are not impeding there being a consistent grip on the item (for example so that the item is being gripped in regions where its shape conforms more closely to the surface of the digits).

Where the sensor signals from the pressure sensing assembly indicates that the item is moving relative to the digits, the digits may be controlled to stop this movement. For example, the digits may be controlled to grip the item more tightly to prevent movement. For example, the digits may be moved in a direction based on the direction of movement of the item, e.g. so that the digits are in a position to oppose this movement of the item. Detection of movement may be based on the magnitude of contact pressure in different regions and/or an indication of direction for the contact pressure.

The system 100 may be configured to pack items based on a determined property for the items. This property may comprise an indication of what type of item they are, such as what fruit or vegetable it is, and/or the property may comprise an indication of the size of the fruit or vegetable. The number of different properties to be sorted may be one or more, such as two, three or four. The system 100 may be configured to allocate a selected property to each open punnet. The system 100 may therefore comprise a plurality of open punnets awaiting selected items, where the selected items are different for each of said open punnets. For each item to be packed, the system 100 is configured to determine the property of the item (e.g. based on size, as described above). Based on this determined property, the system 100 is configured to identify one of the plurality of open punnets into which the item should be placed (e.g. the punnet awaiting items having a selected property which corresponds to the determined property). The system 100 is configured to store an indication of the number of items in each punnet, and to identify when a punnet is full (when a threshold number of items have been placed into a punnet). In the event that the system 100 identifies that a punnet is full, the system 100 is configured to identify a new open punnet into which the relevant items should be placed (e.g. items having a property associated with the selected property for the full punnet).

One example of operation of the system 100 of FIG. 1 will now be described. In this example, the items to be packed are tomatoes. The tomatoes are to be sorted based on size. In particular, two size ranges are defined: the first range is for tomatoes having a diameter between 67 mm and 81 mm, and the second range is for tomatoes having a diameter between 82 mm and 101 mm.

A plurality of tomatoes are placed on the first surface 130 and a plurality of punnets are placed on the second surface 140. Two open punnets are identified: a first open punnet is for tomatoes in the first range, and a second open punnet is for tomatoes in the second range.

The first surface 130 moves the tomatoes towards the first robotic arm 110. The first robotic arm 110 then moves towards a first tomato on the first surface 130, and the digits of the first end effector 120 are controlled so that they move towards grasping the first tomato. The digits are moved towards the first tomato until the pressure sensor indicates that the pressure of the digits grasping the tomato is above a threshold value (e.g. is within a selected threshold range). In the event that it is determined that the pressure is above the threshold value (or within the selected range), it may be determined that the tomato is held properly. The robotic arm 110 is then controlled to lift the tomato. During this movement of the tomato, sensor signals from the pressure sensing assembly are monitored to ensure the item is held correctly. In the event that the tomato is determined not to be held correctly, then the digits will be controlled to change their grip on the tomato so that the tomato is subsequently held correctly. Therefore, during operation the tomato will be held correctly by the end effector 120.

During operation, an indication of a diameter of the tomato is obtained. For example, this may comprise taking a displacement measurement for the digits grasping the first tomato. Based on this displacement measurement, an indication for the diameter of the tomato is identified. Alternatively, or additionally, an indication of a diameter may be obtained using, e.g. a camera and image recognition and analysis to determine a diameter of the tomato. Where a displacement measurement is taken, a pressure measurement may also be taken (or the existing pressure measurement used) to check that the pressure is within a selected range. In the event that the pressure is in the selected range, it may be determined that the first tomato remains held properly, and so the diameter measurement is valid. The first robotic arm 110 then moves the first tomato and places it into one of the first or the second punnets depending on the determined diameter of the tomato. This process is repeated for subsequent tomatoes on the first surface 130.

In the event that a tomato is placed into a punnet, and that punnet is then deemed to be full (e.g. it has six tomatoes in it), that punnet is no longer identified as an open punnet. A new punnet will then be identified as an open punnet for tomatoes in the first or second range (depending on which punnet was filled). It may be that the tomatoes have predetermined punnets into which they are to be placed (e.g. punnets for the first range are different to punnets for the second range). In which case, the next suitable punnet is identified. It may be that the punnets for the first and second ranges are the same. In which case, the next empty punnet is identified as an open punnet for the relevant range. Either way, once a punnet is full, the next open punnet for that range is identified, and tomatoes having a diameter corresponding to that range are then placed into that open punnet.

In the event that a pressure value for a tomato varies while in contact with the digits of the first end effector 120 (e.g. while a diameter measurement is being taken, or while being moved into an open punnet), the digits may be controlled based on this change in pressure value. If the pressure is increasing above a threshold rate, or has increased above a threshold amount (or to above a threshold pressure limit), the digits are opened until the pressure returns to its selected range. At which point, an additional displacement measurement may be obtained to identify to which diameter range that tomato belongs. If the pressure is decreasing above a threshold rate, or has decreased by a threshold amount (or to below a threshold pressure limit), the digits are closed until the pressure returns to its selected range. At which point, an additional displacement measurement may be obtained to identify to which diameter range that tomato belongs.

Tomatoes may therefore be sorted depending on size, and packed accordingly while ensuring that the tomatoes are held securely, but not too tightly, during the process.

It will be appreciated in the context of the present disclosure that the exemplary system 100 and method described above may enable automatic identification and sorting of items of fruit and/or vegetables. This may reduce human error associated with the process (e.g. wrongly gauging size of items, or accidentally placing items in the wrong punnets). This may also increase speed of operation. However, it will also be appreciated that the system 100 and method described above is one specific example of the present disclosure. This example is not to be considered limiting. Features described in this example are not necessarily essential, and systems and methods of the present disclosure may be provided without these features. Likewise, additional and/or alternative features may be provided. The following description is of some of these additional features or alternative arrangements.

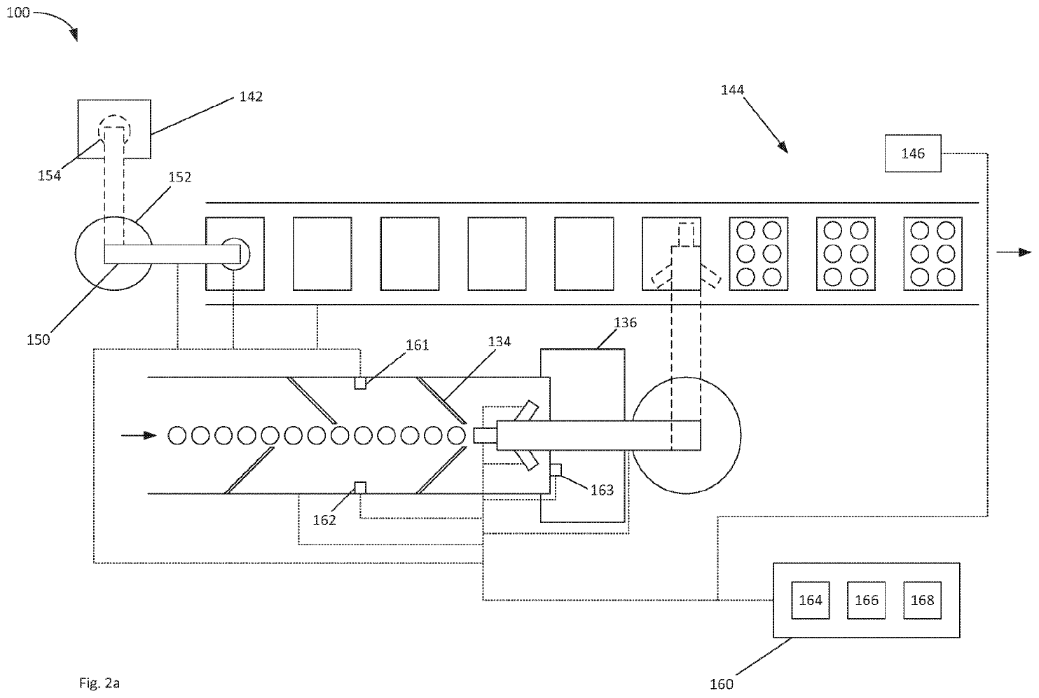

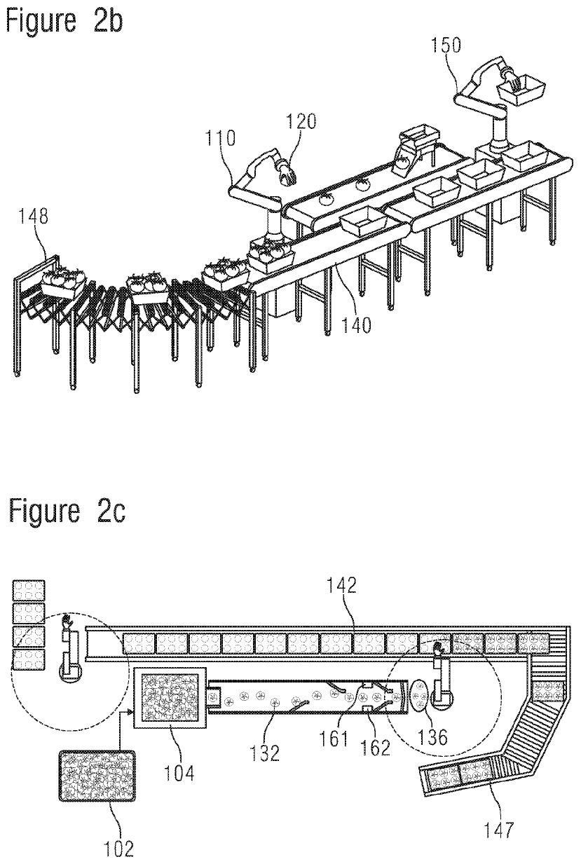

FIGS. 2a to 2c show exemplary fruit and vegetable packing systems 100.

The fruit and vegetable packing system 100 of FIG. 2a includes a number of features which have been described above in relation to FIG. 1, and which will not be described again here.

The system 100 shown in FIG. 2a includes a plurality of item guides 134 and a discard region 136. The system 100 also comprises a control unit 160 which includes data store 164, processor 166 and a communications interface 168. The system 100 includes a plurality of cameras: first camera 161, second camera 162 and third camera 163. The system 100 includes an inspection region 144 and a graphical user interface (GUI) 146. The system 100 also comprises a second robotic arm 150 including a second movable platform 152, and a second end effector 154.

The item guides 134 may be coupled to the first moving surface 130 so that they protrude inwards towards items carried on the first moving surface 130. The item guides 134 may be located upstream of the first robotic arm 110. Item guides 134 may be provided on both sides of the first surface 130 (e.g. on the sides perpendicular to the direction of movement along the first surface 130). The item guides 134 may extend towards a central line of the first surface 130. The discard region 136 may be located at the distal end of the first moving surface 130. For example, the discard region 136 may underlie some of the first moving surface 130, or it may lie flush with the first moving surface 130.

The first and second camera 161, 162 may be located proximal to the first moving surface 130 upstream of the first robotic arm 110 (e.g. towards the proximal end of the first surface 130). At least one of the first and second cameras 161, 162 may be elevated relative to the items on the first surface 130. The third camera 163 may be located within reach of the first robotic arm 110. For example, the third camera 163 may be located proximal to the first end effector 120 of the first robotic arm 110 when the first robotic arm 110 is collecting an item from the first surface 130, and/or it may be located between a collection region of the first surface 130 and an open punnet on the second surface 140 into which the item is to be placed. The third camera 163 may be arranged below the first robotic arm 110, or in a position to above which the digits of the robotic arm may be moved.

The second robotic arm 150 may be arranged at a proximal end of the second moving surface 140. The second robotic arm 150 is provided on top of the second movable platform 152. The second end effector 154 is located at a distal region of the second robotic arm 150. The inspection region 144 is towards the distal end of the second surface 140 distal to a region of the second surface 140 into which the first robotic arm 110 may place items from the first surface 130. The GUI 146 may be located at any suitable location for interaction with an operator of the system 100, such as in a region proximal to the inspection region 144.

The control unit 160 may be connected to one or more of the features of the system 100. The control unit 160 may be connected to one or more of: (i) the first robotic arm 110, (ii) the digits of the first end effector 120, (iii) the cameras, (iv) the first moving surface 130, (v) the second moving surface 140, (vi) the second robotic arm 150, (vii) the second end effector 154 of the second robotic arm 150, and/or (viii) the GUI 146. In FIG. 2a, the control unit 160 is shown as being connected to each of these components (the connections are shown by dashed lines).

The control unit 160 may be located at any suitable location. It is to be appreciated in the context of the present disclosure that communication between different components of the system 100 may be wired or wireless. The control unit 160 may communicate with the components over a network, and so could be located anywhere.

The discard region 136 is arranged to receive items which are not to be placed in punnets (e.g. items which are to be discarded). The discard region 136 may comprise a container arranged to receive the discarded items so that they can be discarded. The discard region 136 may be arranged so that items on the first surface 130 which pass through the collection region, but which are not collected by the first robotic arm 110, may pass into the discard region 136 with the movement of the first surface 130 (e.g. it is located at the distal end of the first surface 130). Items may move directly into the discard region 136, such as by falling off the end of the first surface 130, or they may move indirectly, such as via one or more additional components or guides 134 for directing the items to the discard region 136.

The item guides 134 are arranged to protrude into the path of oncoming items on the first surface 130 to direct the items into an intended location on the first moving surface 130 (e.g. in the middle of the first surface 130). The item guides 134 may funnel the items on the first surface 130 so that they are in single file and/or in a central location on the surface. The item guides 134 may be configured to enable the items to be provided to the first robotic arm 110 one at a time and/or to provide the items on the first surface 130 at a selected, e.g. uniform, distance from the cameras. Item guides 134 may be provided on either or both sides of the first surface 130. For example, one may be provided on either side of the first surface 130 at a selected location along the first surface 130 to provide a funnelling of items on the first surface 130.

The second robotic arm 150 is configured to move in a similar manner to that of the first arm (e.g. it may rotate about a central region and/or the radius of this rotation may be varied). The second robotic arm 150 is arranged at a proximal end of the second moving surface 140. The second robotic arm 150 is operable to move from an empty punnet storage region (where empty punnets are stored) to a region over the second surface 140.

The second end effector 154 is configured to collect individual punnets and to hold these while the second robotic arm 150 transports the punnet onto the second moving surface 140. For example, the second end effector 154 may be configured to provide suction to enable a single punnet to be isolated from a stack of punnets, and to hold that punnet until it is over the second surface 140, e.g. the second end effector 154 may comprise a vacuum system for providing suction.

The inspection region 144 is a region into which full punnets will pass where they may be visible. The inspection region 144 may be configured to enable one or more human inspectors to inspect the full punnets to identify any outliers (e.g. items which do not appear to meet the relevant standard associated with their punnet, or punnets which do not appear to meet their relevant standard).

The GUI 146 is configured to enable an operator to input data regarding operation of the system 100 and/or to control operation of the system 100. For example, the GUI 146 may be configured to enable an operator to input data relating to items and/or punnets which have been observed in the inspection area. As will be described in more detail below, the GUI 146 may be used in combination with one or more machine learning elements of the system 100 to provide a means for incorporating a supervised learning system to further train the machine learning element.

The cameras are arranged to enable images of each item to be obtained. The three cameras may be arranged to enable images to be obtained which provide a full 3-dimensional coverage of the item. For example, the first and second cameras 161, 162 may be arranged to obtain an image of each side of the item. One of the first and/or second cameras 161, 162 may be arranged (e.g. raised relative to the item) to enable an image encompassing the top of the item to be obtained. The third camera 163 may be arranged to enable an image of the bottom of the item to be obtained. The third camera 163 may be arranged in a region which may be able to view the underside of the item when on the first surface 130, and/or the third camera 163 may function in combination with the first robotic arm 110 to obtain an image of the underside of the item. For example, the third camera 163 may be arranged so that the first robotic arm 110 may grasp an item in the digits, and hold the item above the third camera 163 to enable an image of the underside of the item to be obtained.

The system 100 may be configured to control operation of the first surface 130 and the first and second cameras 161, 162 so that at least one image of the item has been obtained before that item enters the collection region. As will be described in more detail below, the images may be used to determine whether or not an item is suitable for packing (e.g. items with blemishes may instead be discarded). The system 100 is configured to enable such determination to happen before an item is to be packed. The system 100 may be configured so that, in the event that it is determined that an item is unsuitable for packing (e.g. after only one or two images have been obtained), no more images may be obtained for that item, and it may pass into the discard region 136. The system 100 is configured to control operation of the first surface 130, the first robotic arm 110 and the cameras to obtain three images for each item for which images obtained from the first or second camera 161, 162 have not revealed that the item is unsuitable for packing. For example, movement of the first surface 130 may be controlled so that items do not pass the first robotic arm 110 while the first robotic arm 110 is packing other items (e.g. the first surface 130 may remain stationary for periods during use).

The system 100 may include one or more lighting elements. The lighting elements are configured to direct light to a region in which the cameras are configured to obtain images of the items. For example, the one or more lighting elements may be configured so that each camera obtains pictures of an illuminated item. The one or more lighting elements may be connected to the cameras and/or control unit 160 to enable lighting to be timed so that it is on when images are to be obtained. For example, each camera may have its own associated light. The lighting element may be arranged to provide lighting to the underside of the item (e.g. to the region for which an image is to be obtained using the third camera 163).

The control unit 160 may be configured to control operation of the system 100. The processor 166 may be configured to read data from the data store 164 and/or write data to the data store 164. The data store 164 may be configured to store data indicative of operating conditions of the system 100. For example, the data store 164 may store an indication of each of the open punnets, how many spaces there are left in the open punnets, and/or any requirements associated with each open punnet (e.g. criteria specifying items that are intended to be placed in that open punnet). The telecommunications interface 168 is configured for communication with other systems or with a central server connected to said systems. Communication may be over any suitable network.

The system 100 may be configured to perform image analysis on the obtained images of items (e.g. as obtained using one or more of the cameras). This image analysis may be performed by the control unit 160. The control unit 160 may control operation of the system 100 based on the image analysis. The system 100 may be configured to perform image analysis on one or more images obtained using the first and/or second cameras 161, 162. The system 100 may be configured to perform further image analysis using an image obtained from the third camera 163. For example, the control unit 160 may be configured to obtain one or more images of the item, and to perform an image processing analysis of these obtained images.

The system 100 may be configured to perform an image analysis on an image of an item to obtain an indication of one or more of the following properties: (i) a colour of the item, (ii) a size of the item, (iii) a type of the item, (iv) a shape of the item and/or (v) the presence of a defect in the item (e.g. which would render the item unsuitable for packing).

As to the colour of the item, the control unit 160 may be configured to process the image to identify the region of the image in which the item is located. The system 100 may be arranged so that the item is always in a similar region of the image (e.g. the timing of the operation of the camera and/or first surface 130 may be controlled so that the item is within a selected region for photographing by the camera). The control unit 160 may be configured to determine the colour of the item based on pixel values for the image (e.g. a red value for the relevant pixels).

Determining the colour may comprise identifying a range of colours within which the item lies. For example, there may be industry standardised colour charts for items of fruit and/or vegetables, such as tomato colour charts (e.g. British Tomato Growers Association colour chart). The control unit 160 may be configured to process the image to determine to which colour group of the different colour groups the item belongs. This processing may comprise use of one or more calibrations, such as having a reference colour in the background of the image which has a known colour value against which the colour of the item may be calibrated.

The control unit 160 may control operation of the system 100 based on the determined colour for the item. The control unit 160 may determine, based on the colour, whether the item is suitable for packing. The control unit 160 may determine, based on the colour, into which open punnet the item should be placed. For example, items may be grouped into a punnet so that all of the items in that punnet are of a similar colour. In which case, each open punnet may have an associated colour range (e.g. as stored in the data store 164 of the control unit 160). The control unit 160 may be configured to identify the colour of an item, and then to place that item into an open punnet associated with that colour. As another example, items may be grouped into a punnet so that each punnet has items of a variety of different colours, such as according to prescribed criteria (e.g. two red, two yellow, two orange). In which case, each open punnet may have associated criteria for the colour of items it requires. The data store 164 may store an indication of these requirements, and each time an item is placed into a punnet, the data store 164 is updated to indicate that said punnet has received an item of that colour. The control unit 160 may be configured to obtain an indication of colour for an item, to determine which open punnet requires an item of that colour, and to control the first robotic arm 110 to place the item into said open punnet (e.g. into the furthest advanced open punnet requiring an item of that colour).

As to the size of the item, the control unit 160 may be configured to process the image of the item to determine its size. The size may be determined based on the size of the region of the image in which the item lies. Again, one or more calibrations may be used to facilitate this determination. For example, the system 100 may comprise one or more reference measurements which will be visible in the image (such as a measurement scale), and/or the system 100 may be configured to control movement of the items along the first surface 130 so that they are a selected distance away from the camera (e.g. a fixed distance). Size may be determined based on a comparison between images from the first and second (and optionally third) camera. The control unit 160 may control operation of the system 100 based on the determined size for the item. For example, punnets may have one or more associated sizes, and the control unit 160 may control the first robotic arm 110 to place each item into a punnet based on the size of the item and the size associated with said punnet. Each open punnet may have one associated size, or may have a plurality of associated sizes.

As to the type of item, the control unit 160 may be configured to process the image of the item to determine its type (e.g. what type or category of fruit or vegetable it is). The system 100 may be operated to receive two or more types of fruit/vegetables and to sort and/or pack these concurrently. The control unit 160 may be configured to process the obtained image of each item and determine therefrom what type of item it is. Determining what type of item it is may comprise determining that the item is one type of item out of a selected list of possible items to be processed. For example, there may be a prescribed number of possible items to be processed, and the image processing may identify which of said prescribed items the item in question most closely resembles. The control unit 160 may be configured to control operation of the first robotic arm 110 based on the determined type of item. For example, open punnets may have one or more associated items, and the control unit 160 is configured to determine into which open punnet to place the item based on the type of item and open punnets associated with that type of item.

As to the shape of the item, the control unit 160 may be configured to process the image of the item to determine its shape. For example, the control unit 160 may be configured to place the shape into one of a plurality of shape categories (e.g. to within selected tolerances of being round). As with the examples above, the control unit 160 may be configured to control operation of the first robotic arm 110 to place the item into an open punnet selected based on the shape of the item and one or more shapes associated with that open punnet.

As to the presence of a defect in the item, the system 100 may be configured to process the image of the item to determine if there are any visible defects with the item. For example, the control unit 160 may identify one or more regions on the surface of the item which deviate from what would be expected (e.g. in shape or colour etc.). These may indicate the presence of a blemish or other deformity with the item. As with the examples above, the control unit 160 may be configured to control operation of the first robotic arm 110 to place the item into an open punnet selected based on whether or not there are any defects associated with the item.

In the examples described above, the system 100 may be controlled to place items into relevant open punnets selected based on one or more determined properties of the item (and selected properties associated with the open punnets). It is to be appreciated that these are just some examples of how the system 100 may be controlled based on determined properties of the items. As another example, the control unit 160 may control operation of the system 100 to determine if an item should be placed into the discard region 136. The control unit 160 may determine whether an item is suitable for packing at all (e.g. as an alternative to, or additionally to, determining where to pack that item). For example, if the determined property for an item does not satisfy threshold criteria for the item/open punnets, then the control unit 160 may be configured to control operation of the system 100 so that said item is sent to the discard region 136.

The examples described above relate to determining one or more properties for items based on obtained image data for said items to be sorted and/or packed. The control unit 160 may be configured to control operation of the first robotic arm 110 based on any one of these determined properties for an item. For example, the control unit 160 may determine where to place an item based on a determined property for that item, e.g. in the event that the control unit 160 determines that a first property is associated with the item, the control unit 160 controls operation of the system 100 to place the item in a location corresponding to said first property associated with the item.

The control unit 160 may be configured to infer additional properties for the item based on the obtained data for the item, and/or the control unit 160 may be configured to determine additional properties for the item based on a combination of obtained data for said item.

As one example, the control unit 160 may be configured to determine an indication of ripeness for the item. The control unit 160 may then sort items into open punnets based on their ripeness. For example, each open punnet may have an associated level of ripeness, and the control unit 160 may allocate items to open punnets based on the determined indication of ripeness of the item (e.g. so that each punnet receives items of the required ripeness for that punnet). The control unit 160 may be configured to provide an indication of ripeness for each full punnet, which may be used to control subsequent use of said punnet (e.g. to provide a use by date etc.).

The control unit 160 may be configured to determine an indication of ripeness based on one or more obtain properties of the item. For example, an indication of ripeness may be obtained using the obtained colour for the item. In which case, sorting items based on their ripeness may comprise sorting items based on their colour. The control unit 160 may be configured to determine ripeness by combining multiple pieces of obtained data for the item. For example, the control unit 160 may obtain an indication of size for the item using image data, and this may be compared to pressure/displacement data obtained for the digits. The control unit 160 may determine an indication of ripeness based on a comparison between: (i) the displacement at which the digits hold the item with pressure in the selected range, and (ii) the determined size of the item obtained using the image data. This combination may provide an indication of how firm the item is. In other words, the control unit 160 may be configured to determine and indication of ripeness/firmness for an item based on a comparison between an estimated size for the item determined using image data and a measured size for the item when held by the digits. The control unit 160 may control operation of the first robotic arm 110 to sort and/or pack the item based on its determined ripeness. Ripeness may be detected using a sensor configured to sense ethylene.

The control unit 160 may be configured to calibrate signals obtained from the pressure sensing assembly (or displacement data) for the item between the digits based on properties of the item obtained using image processing for obtained images of the item. For example, the size of the item may be determined using both a displacement measurement and an obtained indication of shape or ripeness for the item (e.g. less circular items may have smaller or larger displacement readings depending on which points are being measured for the displacement, and/or riper fruits may appear larger in the punnet once not compressed by digits). As another example, an indication of blemishes may be used to calibrate displacement/ripeness measurement, as the blemished region may provide smaller/larger displacement than is representative of the item as a whole. Operation of the robotic arm 110 and effector 120 may be controlled based on an indication of the item type—e.g. if it is determined that the item is of a certain type, then properties of the shape of that item may be considered when monitoring magnitude/direction of contact pressure. For example, if sensor data indicates a difference in pressure between different regions of the item, this may be compared to an indication of an expected shape for that item. In the event that it is considered likely that the difference in pressure is due to the shape of the item, one or more of the digits may be controlled to be moved to a selected location, which is based on the expected shape of the item.

As disclosed herein, the control unit 160 may be configured to control operation of the system 100 depending on the item of fruit or vegetable to be packed. The control unit 160 may control operation of the system 100 according to pressure/displacement ranges which are selected for specific items (this information may be stored in the data store 164). For example, when packing tomatoes, these may be sorted according to tomato-specific sizes (which may be different to apple-specific sizes). The control unit 160 may be configured to obtain an indication of the type of item based on the image analysis, and to select parameters for operation of the system 100 based on the determined type of item.

The control unit 160 may be configured to determine one or more properties about the item based on the obtained indication of the type of item and additional data. For example, the control unit 160 may determine the ripeness based on the type of item (e.g. pear) and the colour of that item (e.g. how red/green the pear is). As another example, the control unit 160 may determine what the item to be sorted is (e.g. a tomato) based on image analysis of that item.

The control unit 160 may determine how to sort the item based on colour based on the type of item, such as to identify selected colour ranges associated with that type of item, and to sort the item according to those selected colour ranges for that type of item.

The control unit 160 may be configured to perform image analysis of the present disclosure using one or more machine learning elements configured for image processing. Exemplary machine learning elements include neural networks such as convolutional neural networks. A detailed example will be described below in relation to blemish detection for items, but it is to be appreciated in the context of the present disclosure that machine learning elements may be used for processing image data to obtain a number of different properties for items. For example, machine learning elements may be trained to determine an indication of any of: (i) item size, (ii) item shape, (iii) item colour, (iv) item type, (v) item suitability.

Training a machine learning element may comprise supervised training in which the element is provided with a plurality of items of input data, each of which being an image of an item having one or more associated properties. For example, when training for colour detection, each input item may be a photo of an item have an associated colour group out of a selection of available colour groups. The element may be trained using a large number of images. In each image, the item will have a known colour group associated therewith, against which the element's predictions may be tested and updated accordingly. Other properties of input items in images will vary in the training data set. In particular, the training data set will include a plurality of items of different shapes and sizes, as well as items in different levels of lighting, at different angles to the camera, and with different surface shading, patterning and/or contouring. The element may therefore be trained to correctly identify colour in items to a high degree of reliability for the vast majority of items likely to pass through the system 100.

Embodiments of the present disclosure may utilise one or more machine learning elements to determine the suitability of an item for sorting and/or packing into an open punnet. The machine learning element may be configured to process an image of an item (e.g. as obtained using one or more of the cameras) and to provide an output indicative of the suitability of that item for sorting and/or packing. For example, the machine learning element may comprise a convolutional neural network.

The machine learning element may be configured to provide an output based on which the control unit 160 may control the system 100 to sort and/or pack the item accordingly. The machine learning element may be a classifier configured to provide an output which is one of a plurality of available options for actions to take with the item. For example, this output may be a binary yes (pack) or no (discard), and the control unit 160 may control the system 100 to pack or discard the item accordingly. As another example, the output may place the item in one of a plurality of quality indicators (e.g. high, medium, low, discard), and the control unit 160 may control the system 100 to pack the item into a selected open punnet (e.g. for high, medium or low quality items), or not to pack at all (e.g. to discard).

Alternatively, or additionally, the output from the machine learning element may be a number indicative of the quality of that item and/or the likelihood of that item being unsuitable for packing. Based on this number, the controller may determine where to place the item. For example, items may be grouped in punnets based on their indicated quality (e.g. items having a quality number in a selected range), or only items having a quality above a threshold level may be packed. The control unit 160 may be configured to output an alert (e.g. to a human operator) for any packed punnets having items which have a lower likelihood of being suitable. The output may indicate any regions of the item in which there are deformities which may render the item unsuitable. The system 100 may be configured to output this information at the GUI 146 and optionally to receive an input from an operator (e.g. in the inspection region 144) as to whether the item is or is not suitable.

The machine learning element is configured to receive, as its input, one or more images of an item. The element is configured to determine the suitability of the item based on the condition of the surface of the item, and/or the overall appearance of the item (e.g. shape, colour, size and/or type). It is to be appreciated in the context of the present disclosure that whether or not an item will be suitability will depend on the intended use, and what items are being inspected. The following description will relate to identifying suitable tomatoes, but it is to be understood that this is just one example, and the disclosure may apply to different items.

The element is configured to detect the presence of one or more deficiencies in the item (e.g. blemishes). These deficiencies may include the presence of animals or other pests (e.g. insects such as mite pests or budworms) which are visible on the surface of the item. Another deficiency may comprise an indication of a breakdown of the item, which may be visible in the form of a change in the shape or colour of the item. Another deficiency may comprise a rotting of the item, which may be visible in the form of a region of the item which is of a distinctly different colour to the rest of the item (this will also normally be a much darker colour than the rest of the item). Another deficiency may comprise a splitting, cracking and/or scarring of the item, which may be visible in the form of a region of the item in which the shape appears to change erratically, or in a manner which is not smooth or consistent with the other contours of the item. Splitting, cracking and/or scarring may also be manifest in substantially darker regions being present in the item. Other deficiencies of the item may comprise unusual shapes (e.g. which deviate substantially from an intended shape, such as circular for some tomatoes), unusual colours (e.g. which deviate substantially from an intended colour, such as red for some tomatoes), and/or unusual sizes (e.g. which are substantially smaller or larger than would be intended). Other deficiencies may include the item not being of the correct type (e.g. not being a tomato).

To improve the reliability and precision of this deficiency identification of the machine learning element, the element may be trained using supervised learning. In training the machine learning element, it is provided with a plurality of different items of input data. Each item of input data will include an image of an item and the element analyses the item to provide an output. The element is then updated based on a comparison of its prediction for the item (e.g. suitable or not) and a known answer for that item (e.g. suitable or not). This process is repeated a large number of times using different images of items. The different input images will include images of items having one or more deficiencies (e.g. defects/blemishes), as well as images of items which do not have any deficiencies. For example, the different input images will include images of items with animals/pests present, items with breakdowns present, rotten items, split/cracked/scarred items. Additionally, input images may also comprise images of different items (e.g. not tomatoes), wrongly-coloured items (e.g. green tomatoes), wrongly-sized items (e.g. very large tomatoes), and/or wrongly-shaped items (e.g. non-circular tomatoes).

Each of the images is associated with an indication of suitability for the item shown. Each image with a deficiency may be associated with an indication of not suitable, and each image of non-blemished tomatoes of normal size/shape/colour is associated with an indication of being suitable. The machine learning element is configured to operate on each item of input data. The output from the machine learning element is then determined and compared to the correct output associated with the image (e.g. the indication of suitability for the item shown). The element is then updated (e.g. weightings changed) based on this comparison (e.g. so that it is more likely that the correct answer would be provided in the future if the same image was analysed by the element). This training process is repeated a large number of times.

To provide improved reliability, the training set may be selected to include images showing all the different types of deficiency that would be expected to be present in the items to be analysed, as well as images of normal, suitable items. The training data set may include images showing items conforming to all of these scenarios. Additionally, for items in each of these scenarios, there may be a plurality of different representations of these items (e.g. a variety of different images of these items). For example, images in the training data set may show: the item at a variety of distances away from the camera, the item in a variety of different lighting levels, the item from a variety of different angles, the item at a variety of different contrast levels, the item at a variety of different resolutions (and both in and out of focus), and/or the item with a variety of different backgrounds (which could be expected in use).

The system 100 is also configured to enable continued training of the machine learning element. Human operators in the inspection region 144 may inspect the items which have been placed in punnets by the system 100. They may provide feedback on this determination (e.g. using the GUI 146), such as to indicate that one or more items in a punnet are or are not suitable. This feedback may be used in combination with the obtained images associated with the relevant item(s). The control unit 160 may be configured to update the machine learning element accordingly, and/or this data may be transmitted from the control unit 160 to a central server (e.g. using the communications interface 168). The central server may receive such data from a plurality of different systems. The central server may use all of this data to determine how to update the machine learning element. The central server may communicate such updates to the relevant systems. Additionally, items stored in the discard region 136 may be maintained so that they too may be inspected to determine if they have been correctly discarded or not.

The system 100 may also be configured to facilitate image analysis of the entire outer surface of each item. For example, the system 100 may comprise a plurality of cameras which are arranged so that between them they are operable to image the entire outer surface of the item. The first robotic arm 110 may be used in combination with one or more cameras to provide this full outer surface imaging functionality. The system 100 may be configured to control movement of the item by the first robotic arm 110 so that the entire outer surface of the item is imaged. For example, the system 100 may be configured to use one camera in combination with the first robotic arm 110 to provide the different angles for the image by the one camera, or the system 100 may be configured to obtain one or more images of the item prior to being held by the first robotic arm 110 (e.g. by the first and/or second arm), and the first robotic arm 110 is configured to manipulate the item so that the regions of the item which we previously not visible are now visible to at least one camera (e.g. to the third camera 163).

FIGS. 2b and 2c show additional views of exemplary fruit and vegetable packing systems.

FIGS. 2b and 2c show similar arrangements to those described above with reference to FIG. 2a, and so the relevant features will not be described again. Additionally, FIGS. 2b and 2c show a crate 102, a hopper 104, a flexible gravity roller 147 and a stopper 148. The crate 102 and hopper 104 are located at the proximal end of the first moving surface 130. The crate 102 is configured to hold a plurality of items which may then be placed into the hopper 104. The hopper 104 is configured to receive the items from the crate 102 and to distribute the items onto the first moving surface 130 (e.g. so that they are placed in single file). The flexible gravity roller 147 and stopper 148 are located at the distal end of the second moving surface 140, and are configured to receive full punnets and store them (at or before the stopper 148).

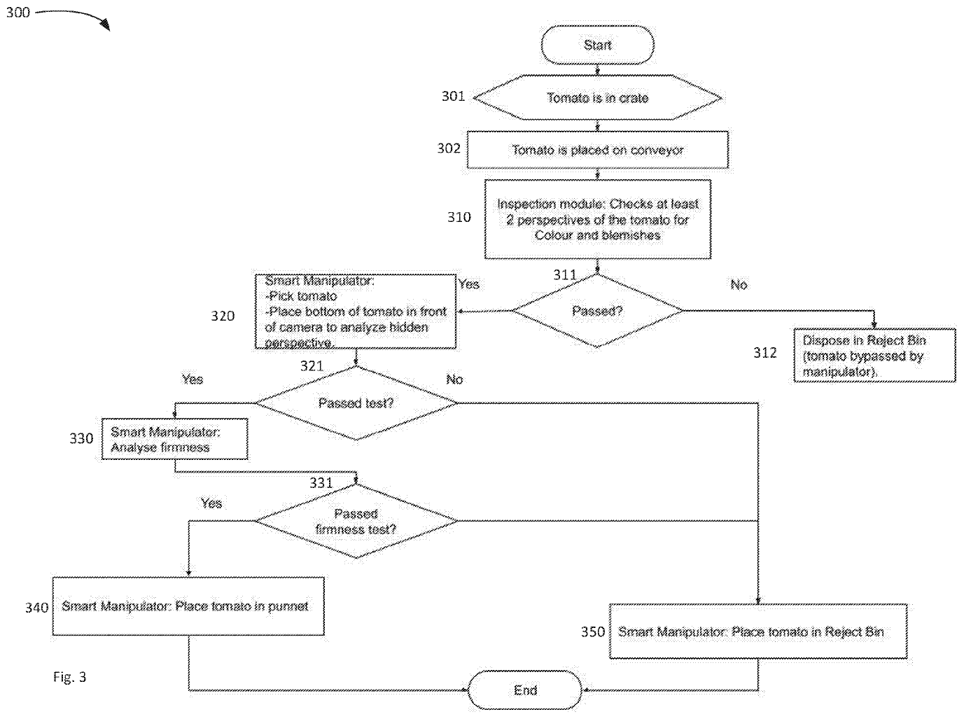

An exemplary method of operation of the fruit and vegetable system 100 of FIGS. 2a to 2c will now be described with reference to FIG. 3. The following description relates mainly to the method steps of determining whether or not an item of fruit or vegetable is suitable to be placed into a punnet. Features of the method described above, such as determining into which of a plurality of different punnets an item is to be placed, may be combined with this method. The method of FIG. 3 shows a method 300. The method of FIG. 3 will be described with reference to packing tomatoes although it will be appreciated that the method may apply to any suitable item of fruit or vegetable.

At step 301, the tomatoes are provided in a crate (e.g. the crate 102 shown in FIGS. 2b and 2c). Although not shown in the flowchart, at this stage, empty punnets may be provided to the empty punnet region.

At step 302, the tomatoes are placed on to the first moving surface 130 (e.g. a conveyor). This may comprise use of the hopper 104 shown in FIGS. 2b and 2c. Although not shown in the flowchart, at this stage, the second robotic arm 150 may be moving empty punnets from the empty punnet region onto the second surface 140. These empty punnets may be moved one at a time so that there is a continuous stream of empty punnets on the first surface 130 (e.g. arranged in a single file line).

At step 310, image data obtained by one or more of the cameras is obtained and inspected to determine if there any defects associated with the tomato. For example, image data may be obtained using the first and/or second cameras 161, 162 (e.g. to provide two different perspectives of the tomato which cover a majority of the exterior surface of the item). At this stage, the image data may also be analysed to determine a colour of the tomatoes. This analysis may be performed by the control unit 160 (e.g. using a machine learning element of the control unit 160 to perform image processing/recognition analysis). Based on the analysis at step 310, it may be determined whether the tomato is suitable for packing (e.g. whether the analysis has identified any substantial blemishes/deficiencies in the tomato), and what colour the tomato is (e.g. into which selected colour range the colour of the tomato falls).

At step 311, it is determined whether the tomato is suitable based on the obtained image data, and optionally if its colour falls within a selected colour range. If it is determined that the tomato is not suitable (e.g. there are one or more major deficiencies), then at step 312 the tomato is discarded. Additionally, or alternatively, if it is determined that the colour of the tomato is not within an accepted colour range, then at step 312, the tomato may be discarded. At step 312, the tomato to be discarded is left on the first moving surface 130, and the first robotic arm 110 is controlled so that it does not move the tomato. The tomato will then move along first moving surface 130 until eventually it falls off the distal end of the first surface 130 and into the discard region 136.

If it is determined that the tomato is suitable and/or has an acceptable colour, the method proceeds to step 320. At step 320, the first robotic arm 110 and first end effector 120 are controlled to grasp the tomato. The tomato is then moved to enable one or more images to be obtained of any regions of the external surface of the tomato which have not previously been imaged. For example, the tomato may be lifted off the first surface 130 and held in a region above (e.g. directly above) one of the cameras (e.g. the third camera 163). Said camera is then used to obtain an image of the underside of the tomato (and any other region of the tomato which had previously been obscured from photographing). A further image analysis is then performed by the control unit 160 (e.g. using the machine learning element). Based on this further image analysis it is determined whether, in light of the newly-obtained images of the previous unseen regions of the tomato, the tomato is suitable (e.g. has no major deficiencies).

At step 321, it is determined whether the tomato is no longer suitable based on the newly-obtained images. In the event that it is determined that the tomato is no longer suitable, then at step 350, the tomato is discarded. To do this, the first end effector 120 and first robotic arm 110 are controlled to move the tomato to the discard region 136 (e.g. the tomato may be dropped from above the discard region 136).

If it is determined that the tomato is suitable in light of the newly-obtained images, then at step 330, the first end effector 120 is operated to determine how firm the tomato is. Here, the digits of the first end effector 120 are brought toward each other (e.g. to reduce their relative displacement) and the pressure is monitored. In so doing, the pressure should increase. If the pressure does not increase, or increases at a rate (pressure per unit change in displacement) below a lower threshold amount, then it may be determined that the tomato is not firm enough. If the pressure increases at a rate above the lower threshold amount and optionally below an upper threshold amount, then it may be determined then the tomato is sufficiently firm.

At step 331, the firmness of the tomato is assessed. If the tomato is deemed to be not firm enough, or too firm, then the method proceeds to step 350, where the tomato is discarded. If the tomato satisfies the firmness test, then the method proceeds to step 340, where the tomato is placed into a selected open punnet. Determining into which punnet to place the tomato may be performed as per the method described above in relation to FIG. 1 (e.g. it may be done based on obtained indication of size or colour etc.). Firmness may be assessed using the Shore OO scale.

Embodiments of the present disclosure may utilise one or more pressure sensors to obtain a pressure measurement for contact between the digits of the first end effector 120 and the item of fruit or vegetable. It is to be appreciated in the context of the present disclosure that any suitable pressure sensor may be used such as strain gauge-based pressure sensing or piezoelectric pressure sensing. Each digit may have a pressure sensor on its item-facing (and contacting) surface. The pressure sensor may be arranged to enable it to measure the pressure of the interaction of the digit holding the item.

Embodiments of the present disclosure may utilise an electronic skin for the digit to provide pressure sensing. For example, each digit may have an electronic skin thereon. The electronic skin may cover the region of the digit which comes into contact with the item during use. The electronic skin may be made from a substrate comprising a base polymer layer, with a first intermediate polymer layer attached to the base polymer layer by a first adhesive layer. The first intermediate polymer layer may comprise a first intermediate polymer in which electron-rich groups are linked directly to one another (or e.g. these may optionally be substituted by C₁₋₄ alkanediyl groups). The skin may further include a first conductive layer attached to the first intermediate polymer layer by a second adhesive layer or by multiple second adhesive layers between which a second intermediate polymer layer or a second conductive layer is disposed. Nanowires may be present on the first conductive layer. The nanowires may comprise a piezoelectric material. Said nanowires may be provided to enable piezoelectric pressure sensing.

In the above described examples, a contact pressure sensing assembly is provided to obtain an indication of a contact pressure between a digit and an item held by that digit. Contact pressure sensors of the present disclosure may comprise piezoresistive sensors. However, it is to be appreciated in the context of the present disclosure that piezoelectric sensors may be used instead of, or in addition to, piezoresistive sensors. Although not shown in the FIGS., an example of a contact pressure sensing assembly will now be described in which both piezoresistive and piezoelectric sensors are used.

Such a contact pressure sensing assembly includes a plurality of piezoresistive sensors and a plurality of piezoelectric sensors. The sensors may be provided as part of an electronic skin. The electronic skin may be affixed to one or more end effectors (e.g. digits) coupled to a robotic arm. In this example, the one or more end effectors and robotic arm will be similar to those described above with reference to FIG. 1. That is, there may be a plurality of end effectors in the form of digits. The digits may be movable relative to one another to hold an item therebetween. The electronic skin is arranged to be affixed to said digits, e.g. it may be adhered (or affixed in another way) to the digits to cover a majority (if not all) of an item contacting portion of the digits. For example, the electronic skin may be configured to cover the digits so that any contact between the digits and the item will include contact between the electronic skin and the item.

The piezoresistive and piezoelectric sensors are spatially distributed about the electronic skin. The sensors may therefore be spatially distributed about the digits, so that each digit comprises one or more piezoresistive sensor, and one or more piezoelectric sensor. Typically, each digit will comprise a plurality of each type of the sensor, e.g. so that the sensors may obtain measurements for a plurality of different regions on the sensor (so that contact pressure sensing may be provided for the majority of the surface of the digits which contact items). For example, the contact pressure sensing assembly may be configured to obtain a plurality of different piezoelectric and piezoresistive sensor measurements for each digit (e.g. for different regions of each said digit).

Each of the sensors is connected to a control unit to enable an indication of a value for one or more parameters of the piezoresistive/piezoelectric signals to be obtained. The control unit is configured to control operation of the robotic arm and digits in the manner described above. That is, the control unit may obtain (e.g. determine) an indication of properties such as: a magnitude of contact pressure, a direction of contact pressure and/or whether the item is moving relative to the digits, and to control operation of the arm and digits based on such indications.

For example, the contract pressure sensing assembly may be configured to monitor parameters of a voltage of the piezoresistive signals, such as a voltage drop associated therewith, to obtain an indication of a contact pressure with the item. Using the plurality of piezoresistive sensors, the system may be configured to obtain a spatial distribution of contact pressures between the digits and the item. Monitoring the piezoresistive signals may enable real-time pressure monitoring to occur, and monitoring the piezoresistive signals may enable a spatial distribution of pressure for the item to be obtained.

The contact pressure sensing assembly may be configured to monitor parameters of a voltage of the piezoelectric signals to obtain an indication of a contact pressure with the item. The system may be configured to monitor any change in voltage for the piezoelectric signal. For example, the system may be configured to monitor any voltage extrema (e.g. maxima or minima for voltage), and/or any change in voltage (e.g. change by more than a threshold amount and/or change at more than a threshold rate). The system may be configured to determine at least one of: (i) a magnitude of any extrema, (ii) a rate of change in the voltage signal, (iii) an absolute value for change in the voltage signal, (iv) a phase associated with an extrema (e.g. peak or trough) in the voltage signal.

The system may be configured to compare different piezoelectric signals to identify any differences between such signals. For example, the system may be configured to compare a piezoelectric signal from a piezoelectric sensor on a first digit with a piezoelectric signal from a piezo electric signal on a second digit, or with a piezoelectric signal from a different piezoelectric sensor on the first digit. The system may be configured to identify one or more regions of interest in the piezoelectric signals. For example, these regions of interest will typically comprise one or more extrema (peaks or troughs), as these may provide an indication of a pressure value. The system may also be configured to monitor piezoelectric signals over time, as changes in the extrema (e.g. changes in their value, or changes in their position) may provide an indication of whether the item is correctly held. For example, the system may be configured to determine that an item is moving relative to the digits in the event that there is a change in one or more voltage extrema for the piezoelectric signals (e.g. in a given time window).

The system may be configured to monitor a position of extrema in the voltage signals from the piezoelectric sensors. The system may be configured to compare the positions for extrema in voltage signals from different sensors to determine both an indication that the item is moving, and also optionally a direction in which the item is moving. For example, the system may be configured to determine a direction of movement for the item based on a difference in phase between the different voltage signals. For example, the system may be configured to determine a direction of movement based on a difference in argument (e.g. sign—positive or negative) for the voltage extrema. For example, a negative sign may indicate movement away and positive movement towards.

The system may be configured to use such piezoelectric sensing to determine an indication of one or more properties of the contact pressure between the digits and the item, such as an indication of a magnitude and/or direction of that pressure, as well as an indication of whether the item is moving relative to the digits. Additionally, the system may be configured to utilise the one or more piezoresistive sensors in combination with said piezoelectric sensors.

It is to be appreciated in the context of the present disclosure that the piezoelectric sensors may provide complementary contact pressure data to that obtained using the piezoresistive sensors. For example, piezoelectric sensors may have a quicker response time, e.g. they may be more time-sensitive to pressure changes. As such, an indication of a change in pressure may first be observed with reference to the piezoelectric signals. It will be appreciated that piezoelectric sensors measure a charge brought about by a force applied to the piezoelectric material. This charge may leak over time (e.g. due to imperfect insulation/internal resistances of sensors and other electrical components connected thereto etc.). However, piezoresistive signals may be maintained overtime.

The system may therefore be configured to determine an ongoing indication of contact pressure for the item using piezoresistive sensors. As such, an indication of a magnitude of pressure at any given moment may be obtained using the piezoresistive sensors. The system may be configured to monitor the piezoelectric signals to identify any changes, e.g. which indicate a change in pressure/movement of the item. The system may be configured so that, in the event that a change in pressure/movement of the item is detected in one or more piezoelectric signals, the piezoresistive signals corresponding to a similar region/digit to those piezoelectric signals will then be monitored to determine a magnitude of the pressure brought about by this change/movement. The robotic arm/end effectors may therefore be controlled based on read outs from both sensors. For example, the end effectors may be initially controlled based on the piezoelectric signal (e.g. to increase/decrease the tightness of their grip—the pressure they apply). The system may then monitor the contact pressure for the relevant region of the item using the piezoresistive sensors to ensure that the contact pressure remains within a selected range. This may enable the system to be more responsive to changes in grip while still ensuring that the grip of the item is not too tight or loose.

The system may be configured to determine how to change its grip (e.g. in response to a change indicated in one or more piezoelectric signals) based on a comparison between different piezoelectric signals. For example, in the event that it is determined that the item is moving in a first direction, the system may be controlled so that one or more of the digits moves position, wherein that movement is controlled based on the determined first direction. For example, a digit may be moved into a position where it counters that movement, e.g. to ensure that the item is held in a stationary manner between the digits.

It is to be appreciated in the context of the present disclosure that the above-described examples of contact pressure sensing assemblies are not to be considered limiting. Instead, this description provides exemplary functionality of the system for controlling the operation of the end effectors/robotic arm when placing items into item containers.

Examples described herein may include systems and methods which use one or more displacement sensors to determine a displacement between the digits of the first end effector 120. It is to be appreciated in the context of the present disclosure that any suitable displacement sensor may be used. Examples described may utilise information from the first robotic arm 110 which has controlled the separation of the digits. However, this is just one example, and this displacement may be measured in other ways. For example, a camera could be used, such as one of the first to third cameras. The camera may process an image of the digits to determine their separation. In other examples, no displacement sensor may be used at all.

One or more cameras may also be used to determine the location of the item on the first surface 130 (e.g. to determine the distance from the digits/first end effector 120 to the item).

One of the first to third cameras may be configured to perform this operation. The control unit 160 may be configured to control operation of the first robotic arm 110 based on this determined location, e.g. to move the first end effector 120 to that region to collect an item. Additionally, or alternatively, the system 100 may comprise a light detection and ranging apparatus (LIDAR). The LIDAR apparatus may be configured to determine a distance to the item of fruit and/or vegetable from the digits of the first robotic. A LIDAR apparatus may be provided for displacement sensing between the digits of the first robotic arm 110. In some examples, the system 100 may be configured so that each item stops in a prescribed location of the first surface 130 where it may be collected by the first robotic arm 110 (e.g. without use of any distance sensing between the first end effector 120 and the item). One or more cameras of the present disclosure may be attached to the robotic arm.

The system 100 may comprise one or more other sensors for measuring properties of the items. For example, the system 100 may comprise a chemical sensor for detecting the chemical composition of an item. The chemical sensor may be provided on one of the digits. For example, the chemical sensor may be arranged so that it comes into contact with the item when the item is collected by the first end effector 120. The control unit 160 may be configured to receive data obtained from the chemical sensor and to control operation of the system 100 based on this obtained data, such as to discard an item if it appears to be defective based on the obtained chemical sensor data. The chemical sensor data may be used in combination with a determination of the type of item to corroborate whether the item determination was correct.

The system 100 may comprise a ripeness sensor. For example, the ripeness sensor may comprise a refractometer such as a brix refractometer configured to obtain an indication of the ripeness of an item. The ripeness sensor may be provided on one of the digits. The ripeness sensor may be arranged so that it comes into contact with the item when the first end effector 120 is holding the item. The control unit 160 may be configured to control operation of the system 100 based on the obtained indication of ripeness (e.g. in a manner similar to that described above except that here there is also data obtained from the ripeness sensor which is indicative of the ripeness).

In examples described herein, the systems and methods of the present disclosure are configured to obtain data for each item and to determine whether to pack that item into a punnet or discard it based on the obtained data. Embodiments of the present disclosure are configured to determine whether the first end effector 120 is correctly holding the item of fruit or the vegetable based on a comparison of an indication provided by the pressure sensor and an indication provided by the displacement sensor. The system 100 may be configured to control sorting and/or packing of the item based on the determination of whether the item is being held correctly. In the event that it is determined that the item is not held correctly, the system 100 may be configured to perform any of a plurality of different actions.

For example, the system 100 may be configured to determine that the item is unsuitable for packing, and the item may be rejected, or rejected for further review (e.g. further images obtained using cameras etc.). The system 100 may be configured to confirm that there are one or deficiencies in the item which render it unsuitable for packing. In these examples, the system 100 may be configured to then discard the item (e.g. place it in the discard region 136). The system 100 may configured to output an alert, such as to alert an operator that there is a potential issue with the item (the operator may then indicate confirm or deny a request to discard the item, and this data may be used for training purposes).

In other examples, in the event that it is determined that an item is not held correctly, the system 100 is configured to try to obtain further measurements for the item. For example, this may comprise trying to obtain the same measurements again (e.g. with pressure/displacement sensor) and/or it may comprise using a different digit, or combination of digits to obtain measurements. The system 100 may be configured to try holding the item differently and then obtain further measurements. For example, the system 100 may be configured to place the item back on the first surface 130 and regather the item with the digits in different locations. Measurements may then be obtained. In the event that the measurements still indicate that the item is not suitable, the item may then be discarded.

In some examples, the system 100 may be configured to utilise obtained data that an item is not held correctly, and to store an indication of this data. For example, an entry corresponding to the rejection may be logged in a database, and this entry may be provided with a timestamp. The database may then store a plurality of indications for items which have been discarded and e.g. the time at which they were discarded. The database may store an indication of one or more measurements of the item and/or an indication of why the item was discarded. Machine learning elements of the system 100 may be trained using such data e.g. by having a human operator confirm whether or not the rejection was indeed correctly determined. This data may then effectively form part of the training data set which is used to update weightings of the machine learning element.

The system 100 may comprise one or more machine learning elements configured to process data obtained from the pressure and/or displacement sensors. In examples described herein, an algorithmic approach may be used to determine if an item is suitable, and if it is suitable, into which open punnet that item should be placed. However, it is to be appreciated in the context of the present disclosure that this functionality may be provided by a machine learning element. For example, the machine learning element may be configured to obtain pressure and displacement data for the item and to use this data to determine if the item is suitable for packing, and if so, into which open punnet the item should be placed. Such a machine learning element may take pressure and/or displacement data for the item as its input. Additionally, the element may also take in additional data, such as an indication of the item type/colour/size/shape/suitability based on obtained data from the cameras. The element may be configured to process this data and to determine how to sort and/or pack the data. Additionally, or alternatively, the element may be configured to process this data to determine if the item is held correctly, and if other measurements are needed prior to packing. Such a machine learning element may be trained in a manner similar to that described above.

Although examples have been described which utilise three cameras, it is to be appreciated that this is only exemplary. The system 100 may not use any cameras (e.g. it may just use data obtained from pressure and/or displacement sensors). The system 100 may only have one camera. For example, the first robotic arm 110 may move the item into a plurality of different positions/angles relative to the camera to enable the entire exterior surface to be imaged. It will also be appreciated that the entire exterior surface need not be imaged. For example, the size/colour/shape etc. may be identified based on an image of some, but not all, of the exterior surface of the item. Likewise, the presence of one or more deformities may be estimated based on only a portion of the exterior surface. The camera may comprise a high-speed camera, e.g. which may be configured to obtain images of the moving item which have high enough resolution to enable image processing to occur (e.g. they are not too blurry).

Apparatuses of the present disclosure may comprise a hopper for receiving items and a chute for receiving an item from the hopper which is to be delivered to a dispenser (e.g. towards the first robotic arm 110). The system 100 may be configured to rotate an item on its way to the dispenser from the hopper. The system 100 may comprise rotating means, such as rollers, which may rotate the item and a camera (e.g. a high-speed camera) which may obtain images of the item as it moves along the chute. The rotating means may be controlled to provide rotation of the item to enable all of the exterior surface of the item to be imaged by the camera. These images may then be used as described above for determining whether or not an item is suitable for packing and/or into which open punnet the item should be placed.

It is to be appreciated in the context of the present disclosure that, while there has been description of the first end effector 120 with three digits, this is not to be considered limiting. There may be two digits, or there may be more than three. The first end effector 120 may comprise an digit which does not move, so that movement of the digits comprises movement of only one (or more than one) digit towards/away from the non-moving digit. For example, the first end effector 120 may comprise a non-moving wall portion in combination with an digit to enable grasping of the item therebetween. It will be appreciated in the context of the present disclosure that, while reference has been made to robotic arms having one or more end effectors, and such end effectors comprising one or more digits, other types of end effector may be provided. For example, one or more end effectors may comprise suction cups or other vacuum-based end effector.

In some examples, systems of the present disclosure may comprise a pressure sensor and a displacement sensor. The pressure sensor may be configured to obtain an indication of a contact pressure between the item and the one or more end effectors, and the displacement sensor may be configured to obtain an indication of a relative displacement between the different end effectors. For example, the system need not comprise a pressure sensor configured to obtain both an indication of a magnitude and a direction of contact pressure, e.g. only a magnitude of contact pressure may be obtained. The system may be configured to control operation of the robotic arm and end effectors based on pressure data (e.g. an indication of magnitude of pressure) and displacement data in the manner described above for the combination of pressure and displacement data.

Exemplary robotic arms (e.g. for the first or second robotic arm) may comprise a robotic arm sold under the trade name Elfin 5 produced by Hans Robot, such as the Elfin5.19 or Elfin5.21. Embodiments of the present disclosure may utilise one or more 3-dimensional cameras, such as those sold under the trade name of MV-CA050-10GC produced by HlKrobotics.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition, the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates. Control units described herein may be provided by any control apparatus such as a general-purpose processor configured with a computer program product configured to program the processor to operate according to any one of the methods described herein.

Machine learning elements described herein may be provided in a number of forms. This may include computer program instructions configured to program a computer processor to operate according to the instructions. The instructions may comprise a finalised machine learning element such that a user may not be able to alter or identify properties associated with the element, or the instructions may be arranged so that they can be overwritten so that continued use of the machine learning element may enable the code to be updated (so as to further develop the element). As will be appreciated in the context of the present disclosure, the specific nature of the machine learning element is not to be considered limiting, and this may vary depending on the nature of data to be processed. Any suitable system for the provision of a machine learning element may be utilised.

The machine learning element may comprise a neural network. A neural network may include a plurality of layers of neurons, where each neuron is configured to process input data to provide output data. It will be appreciated that any suitable process may be provided by any given neuron, and these may vary depending on the type of input data. Each layer of the network may include a plurality of neurons. The output of each neuron in one layer may be provided as an input to one or more (e.g. all) of the neurons in the subsequent layer. Each neuron may have an associated set of weightings which provide a respective weighting to each stream of input data provided to that neuron. Each path from a neuron to a neuron may be referred to as ‘an edge’. Weightings may be stored at each neuron, and/or at each edge.

Such a neural network may have at least two variables which can be modified to provide improved processing of data. Firstly, a neuron's functionality may be selected or updated. Systems and methods of neural architecture search may be used to identify suitable functionalities for neurons in a network. Secondly, the weightings in the network may be updated, such as to alter priorities of different streams of input and output data throughout the network.

The machine learning element may be trained. For example, training the machine learning element may comprise updating the weightings. A plurality of methods may be used to determine how to update the weightings. For example, supervised learning methods may be used in which the element is operated on an input data for which there is a known correct output. That input/output is provided to the machine learning element after it has operated on the data to enable the machine learning element to update itself (e.g. modify its weightings).

This may be performed using methods such as back propagation. By repeating this process a large number of times, the element may become trained so that it is adapted to process the relevant data and provide a relevant output. Other examples for training the machine learning element include use of reinforcement learning, where one or more rewards are defined to enable elements to be trained by identifying and utilising a balance between explorative and exploitative behaviour. For example, such methods may make use of bandit algorithms. As another example, unsupervised learning may be utilised to train the machine learning element. Unsupervised learning methods may make use of principal component and/or cluster analysis to attempt to infer probability distributions for an output based on characteristics of the input data (e.g. which may be associated with known/identified outputs).

The specifics of the machine learning element, and how it is trained, may vary, such as to account for the type of input data to be processed. It will be appreciated that different types of machine learning element may be suited to different tasks or for processing different types of data. It will also be appreciated that data may be cast into different forms to make use of different machine learning elements. For example, a standard neural network could be used for processing numerical input data, such as empirical values from obtained measurements. For processing images, convolutional neural networks may be used, which include one or more convolution layers. Numerical data may be cast into image form, such as by using a form of rasterisation which represents numerical data in image form. A standard file format may be used to which the resulting image must adhere, and a convolutional neural network may then be trained (and used) to analyse images which represent the measurements (rather than values for the measurements themselves). Consequently, the specific type of machine learning element should not be considered limiting. The machine learning element may be any element which is adapted to process a specific type of input data to provide a desired form of output data (e.g. any element which has been trained/refined to provide improved performance at its designated task).

Other examples and variations of the disclosure will be apparent to the skilled addressee in the context of the present disclosure.

1. An item packing system configured to sort and/or pack items into item containers, the system comprising:
a robotic arm;
at least one end effector for holding and manipulating an item to be sorted and/or packed, wherein at least one end effector comprises a pressure sensing assembly; and
a controller configured to receive sensor signals from the pressure sensing assembly to obtain an indication of:
(i) a magnitude of contact pressure for contact between the end effector and the item held by the end effector; and
(ii) a direction of contact pressure for contact between the end effector and the item held by the end effector;
wherein the controller is configured to determine whether the end effector is correctly holding the item based on the indication of the magnitude of the contact pressure and the indication of the direction of contact pressure.

2. The item packing system of claim 1, wherein the system is configured to determine if the end effector is correctly holding the item if both: (i) the indication of the magnitude of contact pressure is within a selected pressure range, and (ii) the indication of the direction of contact pressure is within a selected direction range, wherein the system is configured to receive an indication of the type of item to be sorted and/or packed, and wherein the selected pressure range and/or the selected direction range is selected based on the indication of the type of item.

3. (canceled)

4. The item packing system of claim 1, wherein the system is configured to determine that the end effector is not correctly holding the item if at least one of:
(i) the indication of the magnitude of contact pressure has increased or decreased by more than a first amount;
(ii) the indication of the magnitude of contact pressure is increasing or decreasing by more than a first rate of change;
(iii) the indication of the direction of contact pressure has changed by more than a second amount; and
(iv) the indication of the direction of contact pressure is changing by more than a second rate of change.

5. The item packing system of claim 1, wherein the system is configured to determine that the end effector is not correctly holding the item if at least one of:
(i) the indication of the magnitude of contact pressure is changing while the indication of the direction of contact pressure remains constant; and
(ii) the indication of the direction of contact pressure is changing while the indication of the magnitude of contact pressure remains constant.

6. (canceled)

7. (canceled)

8. The item packing system of claim 1, wherein the controller is configured to:
(i) obtain one or more images of each item to be sorted and/or packed; and
(ii) perform an image analysis on each image to determine whether to pack that item into an item container.

9. The item packing system of claim 8, wherein:
in the event that the controller determines that an item should be packed into an item container based on the image analysis, the controller is configured to control the robotic arm to place said item into a said item container; and
in the event that the controller determines that an item should not be packed into an item container based on the image analysis, the controller is configured to control the robotic arm so that the item is placed into a discard region.

10. The item packing system of claim 8, wherein the controller is configured to obtain at least one image of each item before said item is to be picked up by the one or more end effectors, and in the event that the controller determines that said item should not be packed into an item container based on the image analysis of said at least one image obtained before the item is to be picked up, the controller is configured to control the robotic arm not to pick up the item.

11. The item packing system of claim 9, wherein the controller is configured to obtain at least one image of an item after said item has been picked up by the one or more end effectors, and in the event that the controller determines that said item should not be packed into an item container based on the image analysis of said at least one image obtained after the item has been picked up, the controller is configured to control the robotic arm to place the item in the discard region, for example wherein the end effector is configured to perform a firmness test on the item and, in the event that the item does not pass the firmness test, to place the item into the discard region.

12. (canceled)

13. (canceled)

14. The item packing system of claim 1 wherein in the event that the system determines that the one or more end effectors are not holding the item correctly, the system performs at least one of the following actions:
(i) rejects the item for review;
(ii) logs the rejection in a database, optionally with a timestamp;
(iii) triggers an alert notification;
(iv) returns the item to where it was picked, for example to enable further visual inspection of the item;
(v) attempts to obtain a new indication of the size of the item;
(vi) determines if the item is bruised or damaged; and
(vii) provides feedback for use in training a machine learning algorithm.

15. The item packing system of claim 1 further comprising a light detection and ranging, LIDAR, apparatus for determining a distance to the item.

16. The item packing system of claim 1, wherein the system comprises at least one of: (i) a chemical sensor for detecting the chemical composition of the item held by said end effector, (ii) a ripeness sensor for detecting the ripeness of the item held by said end effector, and (iii) a firmness sensor for detecting how firm the item is, for example wherein the firmness sensor comprises a camera configured to perform visual inspection of the item.

17. The item packing system of claim 1, wherein the pressure sensing assembly comprises an electronic skin made from a substrate comprising:
a base polymer layer;
a first intermediate polymer layer attached to the base polymer layer by a first adhesive layer, the first intermediate polymer layer comprising a first intermediate polymer in which electron-rich groups are linked directly to one another or by optionally substituted C₁₋₄ alkanediyl groups; and
a first conductive layer attached to the first intermediate polymer layer by a second adhesive layer or by multiple second adhesive layers between which a second intermediate polymer layer or a second conductive layer is disposed.

18. A fruit and/or vegetable packing system configured to sort and/or pack items of fruit and/or vegetables into open punnets, wherein the fruit and/or vegetable packing system comprises the item packing system of claim 1.

19. A method of sorting and/or packing items into item containers by a robotic system, the robotic system comprising a robotic arm and one or more end effectors coupled to the robotic arm for holding and manipulating an item, the method comprising:
receiving an indication of a magnitude of contact pressure for contact between at least one end effector and the item held by the one or more end effectors;
receiving an indication of a direction of contact pressure for contact between at least one end effector and the item held by the one or more end effectors;
determining whether the one or more end effectors are correctly holding the item based on the indication of the magnitude of the contact pressure and the indication of the direction of contact pressure.

20. The method of claim 19, wherein the method comprises determining if the one or more end effectors are correctly holding the item if both: (i) the indication of the magnitude of contact pressure is within a selected pressure range, and (ii) the indication of the direction of contact pressure is within a selected direction range.

21-25. (canceled)

26. The method of claim 19, wherein the method comprises determining that the one or more end effectors are not correctly holding the item if at least one of:
(i) the indication of the magnitude of contact pressure has increased or decreased by more than a first amount;
(ii) the indication of the magnitude of contact pressure is increasing or decreasing by more than a first rate of change;
(iii) the indication of the direction of contact pressure has changed by more than a second amount;
(iv) the indication of the direction of contact pressure is changing by more than a second rate of change;
(v) the indication of the magnitude of contact pressure is changing while the indication of the direction of contact pressure remains constant; and
(vi) the indication of the direction of contact pressure is changing while the indication of the magnitude of contact pressure remains constant.

27. A computer readable non-transitory storage medium comprising a program for a computer configured to cause a processor to perform the method of claim 19.

28. The item packing system of claim 1, wherein the system further comprises a camera, and wherein the system is configured to use the camera to provide an indication of at least one of (i) the location and (ii) the size of the item to be sorted and/or packed; and
wherein the system is further configured to move the robotic arm and control the one or more end effectors to pick up the item based on the indication provided by the camera,
wherein the system is configured to determine whether to pack an item into an item container based on the obtained indication of size for the item, for example wherein the system is configured to determine into which of a plurality of item containers to place the item based on the obtained indication of size for the item.

29. The item packing system of claim 1, wherein in the event that the controller determines that the one or more end effectors are not correctly holding the item, the controller is configured to control at least one of the end effectors to move relative to the item, wherein controlling at least one of the end effectors to move comprises at least one of:
(i) moving the end effector inwards to increase its contact pressure on the item in the event that the magnitude of contact pressure is too low;
(ii) moving the end effector outwards to decrease its contact pressure on the item in the event that the magnitude of contact pressure is too high; and
(iii) moving the end effector around the item to a different location on the surface of the item in the event that the direction of contact pressure is not in the correct direction.
